(19) United States
(12) Patent Application Publication
(10) Pub. No.: US 2025/0389836 A1
(43) Pub. Date: Dec. 25, 2025

(54) METHOD AND APPARATUS FOR UTILIZING SENSING INFORMATION IN WIRELESS COMMUNICATION SYSTEM

(71) Applicant: Samsung Electronics Co., Ltd., Suwon-si (KR)

(72) Inventors: Jaeyeon SHIM, Suwon-si (KR); Hyoungju JI, Suwon-si (KR); Ameha Tsegaye ABEBE, Suwon-si (KR); Junyung YI, Suwon-si (KR); Youngrok JANG, Suwon-si (KR)

(21) Appl. No.: 19/244,903

(22) Filed: Jun. 20, 2025

(30) Foreign Application Priority Data
Jun. 21, 2024 (KR) 10-2024-0081380

(51) Int. Cl. G01S 13/04; H04L 5/00; H04W 24/08

(52) U.S. Cl. CPC G01S 13/04; H04L 5/0053; H04W 24/08

(57) ABSTRACT

A 5^{th}-generation (5G) or 6^{th}-generation (6G) communication system for supporting higher data rates are provided. In addition, a method performed by a base station (BS) in a wireless communication system is provided. The method includes obtaining sensing information corresponding to a signal reflected from a sensing object, based on the sensing information, determining whether the sensing object is present in at least one cell, based on determining that the sensing object is present in the at least one cell, activating a main radio (MR) for the at least one cell, and based on determining that the sensing object is not present in the at least one cell, deactivating the MR for the at least one cell of the BS.

### CROSS-REFERENCE TO RELATED APPLICATION(S)

This application is based on and claims priority under 35 U.S.C. § 119(a) of a Korean patent application number 10-2024-0081380, filed on Jun. 21, 2024, in the Korean Intellectual Property Office, the disclosure of which is incorporated by reference herein in its entirety.

### BACKGROUND

### 1. Field

The disclosure relates to an operation by a terminal and a base station in a wireless communication system. More particularly, the disclosure relates to a method by which a base station and a terminal operate a sensing system and utilize, in a wireless communication system, sensing information obtained via the sensing system, and a device capable of performing the method.

### 2. Description of Related Art

The 5^{th}-generation (5G) mobile communication technology defines a wide frequency band to enable fast transmission speeds and new services, and may be implemented not only in a sub-6 gigahertz frequency band (‘Sub 6 GHz’), such as 3.5 gigahertz (3.5 GHZ), but also in an ultra-high frequency band (‘Above 6 GHz’) referred to as millimeter wave (mmWave), such as 28 GHz or 39 GHz. In addition, in the 6^{th}-generation (6G) mobile communication technology, which is referred to as the post-5G communication (Beyond 5G) system, implementation in a terahertz (THz) band (such as 3 terahertz (3 THz) band at 95 GHZ) has been considered to achieve a transmission speed that is 50 times faster than that of 5G mobile communication technology and an ultra-low latency that is reduced to one-tenth.

In early stages of 5G mobile communication technology, with the goals of supporting services and satisfying performance requirements for enhanced mobile broadband (eMBB), ultra-reliable low-latency communications (URLLC), massive machine-type communications (mMTC), standardization was made for beamforming and massive multiple-input multiple-output (massive MIMO) for mitigating a path loss of radio waves in ultra-high frequency bands and increase a transmission distance of radio waves, support for various numerology and dynamic operation of slot formats (for efficient use of ultra-high frequency resources (such as operation of a plurality of subcarrier spacings), initial access technology for supporting multibeam transmission and wideband, definition and operation of band-width part (BWP), new channel coding methods, such as low density parity check (LDPC) codes for large-capacity data transmission and polar code for reliable transmission of control information, and network slicing for providing a dedicated network specialized for a specific service.

Currently, discussions are underway on improvement and performance enhancement of the initial 5G mobile communication technology based on services that the 5G mobile communication technology intended to support, and physical layer standardization is in progress for technologies, such as vehicle-to-everything (V2X) to assist in driving decisions of autonomous vehicles and increase user convenience based on the location and status information thereof transmitted by the vehicle, new radio unlicensed (NR-U) for the purpose of system operation that complies with various regulatory requirements in unlicensed bands, new radio (NR) terminal low power consumption technology (UE power saving), a non-terrestrial network (NTN), which is direct terminal-satellite direct communication for ensuring coverage in areas where communication with terrestrial networks is impossible, or positioning. In addition, research is being conducted on an integrated sensing system (integrated sensing communication) using wireless communication and radio frequency (RF) signals as one of the advanced 5G and 6G mobile communication candidate technologies.

In addition, standardization of wireless interface architecture/protocols is also in progress for technologies, such as industrial Internet of things (IIoT) for supporting new services through linkage and convergence with other industries, integrated access and backhaul (IAB) for providing nodes for expanding network service areas by integrating and supporting wireless backhaul links and access links, mobility enhancement including conditional handover and dual active protocol stack (DAPS) handover, or 2-step random-access channel (RACH) for new radio (NR) for simplifying random access procedures. In addition, standardization of system architecture/services is also in progress for 5G baseline architecture (e.g., service based architecture or service based interface) grafting network functions virtualization (NFV) and software-defined networking (SDN) technologies, or mobile edge computing (MEC) for providing services based on a location of a terminal.

When such 5G mobile communication systems are commercialized, connected devices growing at an explosive rate will be connected to a communication network, and accordingly, it is expected that functions and performance of 5G mobile communication systems will be strengthened, and that integrated operation of connected devices will be required. To this end, new research will be conducted on extended reality for efficiently supporting augmented reality (AR), virtual reality (VR), or mixed reality (MR), improving 5G performance and reducing complexity by using artificial intelligence (AI) and machine learning (ML), AI service support, meta service support, or drone communication.

In addition, the development of these 5G mobile communication systems may serve as a basis for the development of new waveforms to ensure coverage in the terahertz band of 6G mobile communication technology, multi-antenna transmission technologies, such as full dimensional MIMO (FD-MIMO), array antenna, and large scale antenna, metamaterial-based lenses and antennas to improve the coverage of terahertz band signals, high-dimensional spatial multiplexing technology using orbital angular momentum (OAM), and reconfigurable intelligent surface (RIS) technology, as well as full duplex technology to improve the frequency efficiency and system network of 6G mobile communication technology, satellite, and AI-based communication technology that utilizes AI from the design stage and embeds end-to-end AI support functions to realize system optimization, and ultra-high-performance communication and computing resources to provide services with a level of complexity that goes beyond the limits of terminal computing capabilities.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of effectively providing services in a mobile communication system.

Additional aspects will be set forth in part in the description which follows and, in part, will be apparent from the description, or may be learned by practice of the presented embodiments.

In accordance with an aspect of the disclosure, a method performed by a base station (BS) in a wireless communication system is provided. The method includes obtaining sensing information corresponding to a signal reflected from a sensing object, based on the sensing information, determining whether the sensing object is present in at least one cell, based on determining that the sensing object is present in the at least one cell, activating a main radio (MR) for the at least one cell, and based on determining that the sensing object is not present in the at least one cell, deactivating the MR for the at least one cell of the BS.

The method further includes operating in a sensing receive-only mode, receiving, an uplink (UL) signal transmitted by at least one user equipment (UE) on a pre-configured sensing resource, based on the received UL signal, identifying the sensing object as the at least one UE, and based on the identifying the sensing object as the at least one UE, activating the MR for the at least one cell.

The method, when activating the MR for the at least one cell, further includes indicating, to the MR for the at least one cell, to start monitoring a UL signal transmitted by at least one user equipment (UE) on a pre-configured sensing resource, receiving, the uplink (UL) signal transmitted by the at least one UE on the pre-configured sensing resource, based on the received UL signal, identifying the sensing object as the at least one UE, and based on the identifying the sensing object as the at least one UE, transmitting, via the MR for the at least one cell of the BS, downlink (DL) data channel to the at least one UE.

The method further includes transmitting, to a user equipment (UE), sensing related configuration information, receiving, a sensing signal transmitted by at least one UE based on the sensing related configuration information, based on the sensing signal, identifying the sensing object as the at least one UE, and based on the identifying the sensing object as the at least one UE, activating the MR for the at least one cell of the BS.

The method further includes configuring, a cell-specific sensing resource for the at least one cell, as at least a portion of a downlink (DL) resource, uplink (UL) resource, or flexible resource based on time division duplex (TDD) UL-DL configuration information, and performing sensing on the at least one cell based on the cell-specific sensing resource for the at least one cell.

The method further includes configuring, for the at least one cell, a periodicity of the cell-specific sensing resource.

The method further includes configuring, for the at least one cell, a monitoring periodicity of the signal reflected from the sensing object.

The method further includes transmitting, to a user equipment (UE), sensing related configuration information, and transmitting, on the at least one cell of the BS, to the UE, a sensing signal on a pre-configured sensing resource, based on the sensing related configuration information, wherein, based on the sensing signal, the MR of the UE is activated to perform downlink (DL) channel monitoring.

In accordance with an aspect of the disclosure, a method performed by a user equipment (UE) in a wireless communication system is provided. The method includes receiving, from a base station (BS), sensing related configuration information, and transmitting, to at least one cell of the BS, an uplink (UL) signal on a pre-configuration sensing resource, based on the sensing related configuration information, wherein, when the UL signal is received by the at least one cell of the BS, a main radio (MR) for the at least one cell of the BS is activated, and wherein, when the UL signal is note received by the at least one cell of the BS, the MR for the at least one cell of the BS is deactivated.

The method further includes monitoring a sensing signal on the pre-configured sensing resource, based on the sensing related configuration information, based on whether the sensing signal is received on the pre-configured sensing resource from the at least one cell of the BS, identifying whether the MR for the at least one cell of the BS is activated or is deactivated, based on identifying that the MR for the at least one cell of the BS is activated, activating a MR of the UE to perform downlink (DL) channel monitoring, and based on identifying that the MR for the at least one cell of the BS is deactivated, deactivating the MR of the UE.

The method further includes receiving, from the BS, information on a time period for activating the MR of the UE, when determining that the MR for the at least one cell of the BS is activated, waiting for the time period, and after the time period, activating the MR of the UE to perform DL channel monitoring.

In accordance with an aspect of the disclosure, a base station (BS) in a wireless communication system is provided. The BS includes at least one transceiver, at least one processor communicatively coupled to the at least one transceiver, and at least one memory, communicatively coupled to the at least one processor, storing instructions executable by the at least one processor individually or in any combination to cause the BS to obtain sensing information corresponding to a signal reflected from a sensing object, based on the sensing information, determine whether the sensing object is present in at least one cell, based on determining that the sensing object is present in the at least one cell, activate a main radio (MR) for the at least one cell, and based on determining that the sensing object is not present in the at least one cell, deactivate the MR for the at least one cell of the BS.

The instructions are further executable by the at least one processor individually or in any combination to cause the BS to operate in a sensing receive-only mode, to receive, an uplink (UL) signal transmitted by at least one user equipment (UE) on a pre-configured sensing resource, based on the received UL signal, to identify the sensing object as the at least one UE, and based on the identifying the sensing object as the at least one UE, to activate the MR for the at least one cell.

When activating the MR for the at least one cell, the instructions are further executable by the at least one processor individually or in any combination to cause the BS to indicate, to the MR for the at least one cell, to start monitoring a UL signal transmitted by at least one user equipment (UE) on a pre-configured sensing resource, to receive, the uplink (UL) signal transmitted by the at least one UE on the pre-configured sensing resource, based on the received UL signal, to identify the sensing object as the at least one UE, and based on the identifying the sensing object as the at least one UE, to transmit, via the MR for the at least one cell of the BS, downlink (DL) data channel to the at least one UE.

The instructions are further executable by the at least one processor individually or in any combination to cause the BS to transmit, to a user equipment (UE), sensing related configuration information, to receive, a sensing signal transmitted by at least one UE based on the sensing related configuration information, based on the sensing signal, to identify the sensing object as the at least one UE, and based on the identifying the sensing object as the at least one UE, to activate the MR for the at least one cell of the BS.

The instructions are further executable by the at least one processor individually or in any combination to cause the BS to configure, a cell-specific sensing resource for the at least one cell, as at least a portion of a downlink (DL) resource, uplink (UL) resource, or flexible resource based on time division duplex (TDD) UL-DL configuration information, and to perform sensing on the at least one cell based on the cell-specific sensing resource for the at least one cell.

The instructions are further executable by the at least one processor individually or in any combination to cause the BS to transmit, to a user equipment (UE), sensing related configuration information, and to transmit, on the at least one cell of the BS, to the UE, a sensing signal on a pre-configured sensing resource, based on the sensing related configuration information, wherein, based on the sensing signal, the MR of the UE is activated to perform downlink (DL) channel monitoring.

In accordance with an aspect of the disclosure, a user equipment (UE) in a wireless communication system is provided. The UE includes at least one transceiver, at least one processor communicatively coupled to the at least one transceiver, and at least one memory, communicatively coupled to the at least one processor, storing instructions executable by the at least one processor individually or in any combination to cause the UE to receive, from a base station (BS), sensing related configuration information, and transmit, to at least one cell of the BS, an uplink (UL) signal on a pre-configuration sensing resource, based on the sensing related configuration information, wherein, when the UL signal is received by the at least one cell of the BS, a main radio (MR) for the at least one cell of the BS is activated, and wherein, when the UL signal is note received by the at least one cell of the BS, the MR for the at least one cell of the BS is deactivated.

The instructions are further executable by the at least one processor individually or in any combination to cause the UE to monitor a sensing signal on the pre-configured sensing resource, based on the sensing related configuration information, based on whether the sensing signal is received on the pre-configured sensing resource from the at least one cell of the BS, to identify whether the MR for the at least one cell of the BS is activated or is deactivated, based on identify that the MR for the at least one cell of the BS is activated, to activate a MR of the UE to perform downlink (DL) channel monitoring, and based on identify that the MR for the at least one cell of the BS is deactivated, to deactivate the MR of the UE.

The instructions are further executable by the at least one processor individually or in any combination to cause the UE to receive, from the BS, information on a time period for activating the MR of the UE, when determining that the MR for the at least one cell of the BS is activated, to wait for the time period, and after the time period, to activate the MR of the UE to perform DL channel monitoring.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of a time-frequency domain, which is a wireless resource region in which data or control channels are transmitted in a 5^{th}-generation (5G) system according to an embodiment of the disclosure;

FIG. 2 is a diagram illustrating a frame, subframes, and a slot structure in a wireless communication system according to an embodiment of the disclosure;

FIG. 3 is a diagram illustrating a bandwidth part configuration in a wireless communication system according to an embodiment of the disclosure;

FIG. 4 is a diagram illustrating a control resource set (CORESET) on which a downlink control channel is transmitted in a 5G wireless communication system according to an embodiment of the disclosure;

FIG. 5 is a diagram illustrating a basic unit of time and frequency resources constituting a downlink control channel which is usable in 5G according to an embodiment of the disclosure;

FIG. 6 is a diagram illustrating a method of transmitting and receiving data by a base station and a terminal considering a downlink data channel and a rate matching resource according to an embodiment of the disclosure;

FIG. 7 is a diagram illustrating frequency axis resource assignment of a physical downlink shared channel (PDSCH) in a wireless communication system according to an embodiment of the disclosure;

FIG. 8 is a diagram illustrating time axis resource assignment of a PDSCH in a wireless communication system according to an embodiment of the disclosure;

FIG. 9 is a diagram illustrating time axis resource assignment according to subcarrier spacing of a data channel and a control channel in a wireless communication system, according to an embodiment of the disclosure;

FIG. 10 is a diagram illustrating discontinuous reception (DRX) in a 5G communication system according to an embodiment of the disclosure;

FIG. 11 is a diagram illustrating a sensing method and mode according to a sensing transmitter and receiver of an integrated sensing and communication (ISAC) system according to an embodiment of the disclosure;

FIG. 12A is a diagram illustrating methods of configuring a ISAC system according to an embodiment of the disclosure;

FIG. 12B is a diagram illustrating methods of configuring a ISAC system according to an embodiment of the disclosure;

FIG. 12C is a diagram illustrating methods of configuring a ISAC system according to an embodiment of the disclosure;

FIG. 13A is a diagram illustrating sensing system resources operated in a time-division duplex (TDD) band of an ISAC system according to an embodiment of the disclosure;

FIG. 13B is a diagram illustrating sensing system resources operated in a time-division duplex (TDD) band of an ISAC system according to an embodiment of the disclosure;

FIG. 13C is a diagram illustrating sensing system resources operated in a time-division duplex (TDD) band of an ISAC system according to an embodiment of the disclosure;

FIG. 14 is a diagram illustrating a method of activating/deactivating a communication system, performed by a base station, using sensing information, according to an embodiment of the disclosure;

FIG. 15 is a diagram illustrating a method of activating/deactivating a communication system, performed by a base station, using sensing information, according to an embodiment of the disclosure;

FIG. 16 is a diagram illustrating a method of determining whether a terminal is present, when a base station performs sensing, according to an embodiment of the disclosure;

FIG. 17 is a diagram illustrating a method of determining whether a terminal is present, when a base station performs sensing, according to an embodiment of the disclosure;

FIG. 18 is a diagram illustrating a method of determining whether a terminal is present, when a base station performs sensing, according to an embodiment of the disclosure;

FIG. 19 is a diagram illustrating a method of activating a terminal communication system according to a cell status of a terminal, according to an embodiment of the disclosure;

FIG. 20 is a diagram illustrating a structure of a terminal in a wireless communication system according to an embodiment of the disclosure; and

FIG. 21 is a diagram illustrating a structure of a base station in a wireless communication system according to an embodiment of the disclosure.

The same reference numerals are used to represent the same elements throughout the drawings.

### DETAILED DESCRIPTION

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “^{˜}unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a CPU), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the present disclosure may provide a program comprising code for implementing apparatus or a method as claimed in any one of the claims of this specification and a non-transitory machine-readable storage storing such a program.

Hereinafter, the determination of priority between A and B in the present disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the present disclosure may be understood as “A and/or B,” which may include A, or B, or both A and B.

In addition, “at least one of A, B, and C” as described in the present disclosure may be understood to include A, or B, or C, or any combination of A, B, and C.

In addition, “at least one of A, B, or C” as described in the present disclosure may be understood to include A, or B, or C, or any combination of A, B, and C.

Furthermore, “A/B” as described in the present disclosure may be understood as “A and/or B,” which may include A, or B, or both A and B.

Furthermore, “A, B” as described in the present disclosure may be understood as “A and/or B,” which may include A, or B, or both A and B.

Furthermore, “A and B” as described in the present disclosure may be understood as “A and/or B,” which may include A, or B, or both A and B.

Furthermore, “if condition A and condition B are satisfied,” as described in the present disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first˜”, “second˜”, etc., as described in the present disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first˜” and “second˜” are described in the present disclosure, it may be understood that element(s) referred to by “first˜” and “second˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon)˜,” “in response to ˜,” “based on˜,” or “according to ˜,” and may be used interchangeably with these expressions. In addition, expressions other than those exemplified herein may also be used, as long as they have substantially the same meaning and do not impair the technical features of the present disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as L3 (layer 3) signaling. It should be noted, however, that the higher layer signaling is not limited to the aforementioned examples.

In addition, the term “not perform” as used in the present disclosure or claims may, in context, be understood to mean that the corresponding step is omitted or skipped. Such a term may be replaced with other terms having the same or substantially equivalent meaning.

In addition, “transmitting a message including A and B” as described in the present disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the present disclosure described below, terms or components included in the disclosure may be expressed in singular or plural form depending on the specific embodiments presented. However, such singular or plural expressions are selected appropriately for convenience of description, and the present disclosure is not limited to a singular or plural number of components. A component expressed in the plural form may be implemented as a single component, and a component expressed in the singular form may be implemented as multiple components.

The drawings or flowcharts described below illustrate exemplary methods that may be implemented according to the principles of the present disclosure, and various modifications may be made to the methods illustrated in the flowcharts of the present disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the present disclosure are not limited to each embodiment individually, but may also be applied in combination of all or some of the embodiments proposed in the disclosure. Therefore, the embodiments of the present disclosure may be modified and applied without significantly departing from the scope of the present disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the present disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a gNode B, an eNode B, a Node B, a base station (BS), a wireless access unit, a BS controller, or a node on a network.

Furthermore, the base station of the present disclosure may include a split architecture comprising a central unit (CU) and a distributed unit (DU). In this structure, the CU is configured to process the higher layers of the control and user planes, while the DU is configured to process lower-layer radio resource functions. The embodiments of the present disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the present disclosure may also be applied to other communication systems having similar technical backgrounds or channel types. For example, newly evolved mobile communication systems developed after 5G and 6G may be included. Furthermore, based on determinations by those skilled in the art, the embodiments of the present disclosure may also be applied to other communication systems (e.g., Wi-Fi systems) through some modifications without significantly departing from the scope of the present disclosure

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the present disclosure, the expression “transmit a physical channel” may be interpreted as being equivalent to the expression “transmit data or a signal via a physical channel.”

Hereinafter, in the context of the present disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 (layer 3) signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the present disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the present disclosure will be described in detail with reference to the accompanying drawings.

### [NR Time-Frequency Resource]

Hereinafter, a frame structure of a 5G system is described with reference to the accompanying drawings.

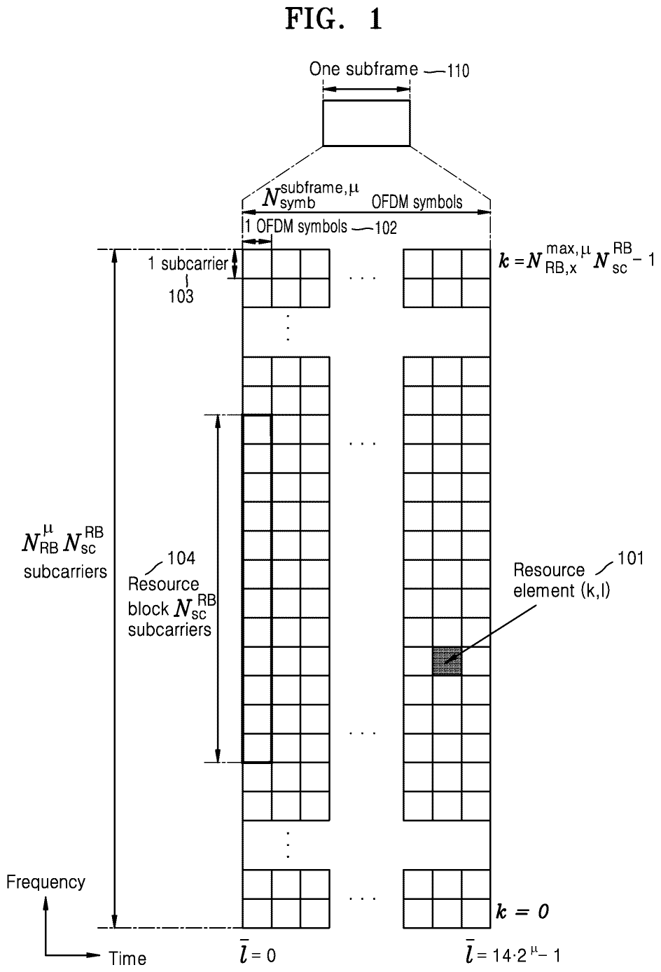

FIG. 1 is a diagram illustrating a basic structure of a time-frequency domain, which is a wireless resource domain on which data or control channels are transmitted in a 5G system according to an embodiment of the disclosure.

Referring to FIG. 1, a horizontal axis represents a time domain and a vertical axis represents a frequency domain. A basic unit of resources in the time-frequency domain is a resource element (RE) 101 and may be defined as one orthogonal frequency division multiplexing (OFDM) symbol 102 on the time domain and one subcarrier 103 on the frequency domain. In the frequency domain,

$${N}_{SC}^{RB}$$

(e.g., 12) consecutive REs may constitute one resource block (RB) 104.

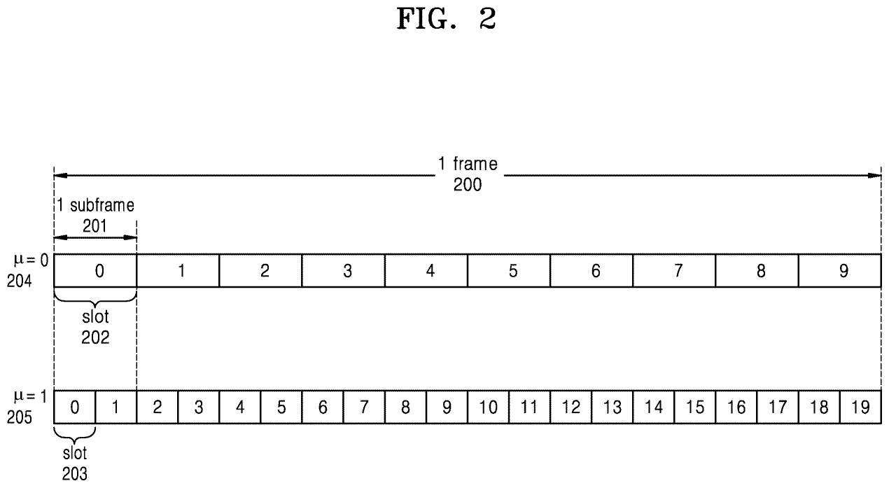

FIG. 2 is a diagram illustrating a frame, subframes, and a slot structure in a wireless communication system according to an embodiment of the disclosure.

Referring to FIG. 2, a structure of a frame 200, a subframe 201, and a slot 202 is illustrated. One frame 200 may be defined as 10 ms. One subframe 201 may be defined as 1 ms. Therefore, one frame 200 may include a total of 10 subframes 201. One slot 202 or 203 may be defined as 14 OFDM symbols (that is, the number

$${N}_{symb}^{slot}$$

of symbols per slot=14). One subframe 201 may include one or more slots 202 and 203, and the number of slots 202 and 203 per one subframe 201 may vary depending on a configured value μ (204, 205) for subcarrier spacing. In the example of FIG. 2, the case of μ=0 (204) and the case of μ=1 (205) are shown as subcarrier spacing configuration values. When μ=0 (204), one subframe 201 may include one slot 202, and when μ=1 (205), one subframe 201 may include two slots 203. For example, the number

$${N}_{slot}^{subframe , μ}$$

of slots per one subframe may vary according to the configured value μ for the subcarrier spacing, and thus, the number

$${N}_{slot}^{frame , μ}$$

of slots per one frame may vary.

$${N}_{slot}^{subframe , μ} and {N}_{slot}^{frame , μ}$$

according to each subcarrier spacing configuration value μ may be defined as shown in Table 1 below.

TABLE 1

| μ | ${N}_{s y m b}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

A BWP configuration in a 5G communication system will now be described with reference to the drawings.

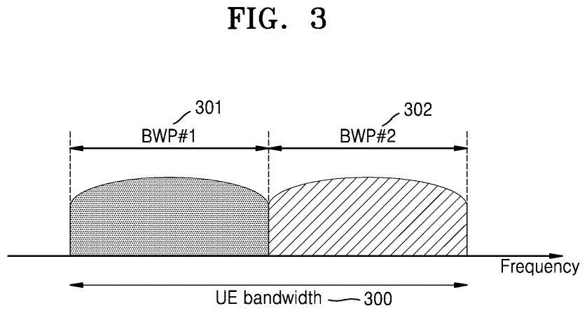

FIG. 3 is a diagram illustrating a BWP configuration in a wireless communication system according to an embodiment of the disclosure.

Referring to FIG. 3, a UE bandwidth 300 being configured as two BWPs, that is, BWP #1 301 and BWP #2 302 is illustrated. The BS may configure one or more BWPs to the UE, and may configure the following information as in Table 2 below, for each BWP.

TABLE 2

| BWP ::= | SEQUENCE { | |
|---|---|---|
| bwp-Id | BWP-Id, | |
| (BWP identity) | | |
| locationAndBandwidth | INTEGER (1..65536), | |
| (BWP position) | | |
| subcarrierSpacing | ENUMERATED {n0, n1, n2, n3, | |
| n4, n5}, | | |
| (Subcarrier spacing) | | |
| cyclicPrefix | ENUMERATED | { |

```
  extended }
  (Cyclic prefix)
}
```

However, the disclosure is not limited thereto, and various parameters related to a BWP in addition to the configuration information may be configured in the UE. The BS may transmit the information to the UE through higher-layer signaling, for example, radio resource control (RRC) signaling. At least one BWP among the configured one or more BWPs may be activated. Whether the configured BWP is activated may be semi-statically transmitted from the BS to the UE through RRC signaling or may be dynamically transmitted through DL control information (DCI).

According to some embodiments of the disclosure, the UE before RRC connection may be configured with an initial BWP for initial connection through a master information block (MIB) from the BS. More particularly, the UE may receive configuration information for a search space and a CORESET where a physical DL control channel (PDCCH) may be transmitted to receive system information (e.g., remaining system information (RMSI) or system information Block 1 (SIB1)) required for initial access through the MIB in an initial access stage. An identity (ID) of the CORESET and the search space configured through the MIB may be considered as 0. The BS may notify configuration information, such as frequency assignment information, time assignment information, and a numerology for a CORESET #0 through the MIB to the UE. In addition, the BS may notify configuration information for monitoring periodicity and an occasion for the CORESET #0, that is, configuration information for a search space #0, through the MIB to the UE. The UE may consider a frequency domain configured as the CORESET #0 obtained from the MIB as the initial BWP for initial access. In this case, an ID of the initial BWP may be considered as 0.

The configuration of the BWP supported by the 5G may be used for various purposes.

According to some embodiments of the disclosure, when a bandwidth supported by a UE is smaller than a system bandwidth, a BS may support the UE through a BWP configuration. For example, the BS configures a frequency location (configuration information 2) of a BWP in the UE so that the UE transmits and receives data at a specific frequency location within the system bandwidth.

In addition, according to some embodiments of the disclosure, the BS may configure a plurality of BWPs in the UE to support different numerologies. For example, in order to support, to a certain UE, data transmission and reception using both a subcarrier spacing of 15 kHz and a subcarrier spacing of 30 kHz, two BWPs may be configured with a subcarrier spacing of 15 kHz and 30 kHz, respectively. Different BWPs may be frequency division multiplexed, and when data is to be transmitted and received at a specific subcarrier spacing, a BWP configured as the specific subcarrier spacing may be activated.

In addition, according to some embodiments of the disclosure, the BS may configure BWPs having different bandwidths in the UE so as to reduce power consumption of the UE. For example, when the UE supports a very large bandwidth, for example, a bandwidth of 100 MHz, and always transmits and receives data in the corresponding bandwidth, very high power consumption may occur. More particularly, monitoring an unnecessary DL control channel with a large bandwidth of 100 MHz in a situation in which traffic is absent may be very inefficient in terms of power consumption. In order to reduce power consumption of the UE, the BS may configure, to the UE, a BWP of a relatively small bandwidth, for example, a BWP of 20 MHz. In a situation where traffic is absent, the UE may perform the monitoring operation in the 20 MHz BWP, and when data is generated, the UE may transmit and receive data in a BWP of 100 MHz according to an indication of the BS.

In the above method of configuring a BWP, UEs before RRC connection may receive configuration information regarding an initial BWP through an MIB in an initial access stage. More specifically, the UE may be configured with a CORESET for a DL control channel through which DCI for scheduling a system information block (SIB) may be transmitted from an MIB of a physical broadcast channel (PBCH). A bandwidth of the CORESET configured through the MIB may be considered as an initial BWP, and the UE may receive a physical DL shared channel (PDSCH) via which the SIB is transmitted through the configured initial BWP. In addition to the purpose of receiving the SIB, the initial BWP may be utilized for other system information (OSI), paging, and random access.

### [Change in BWP]

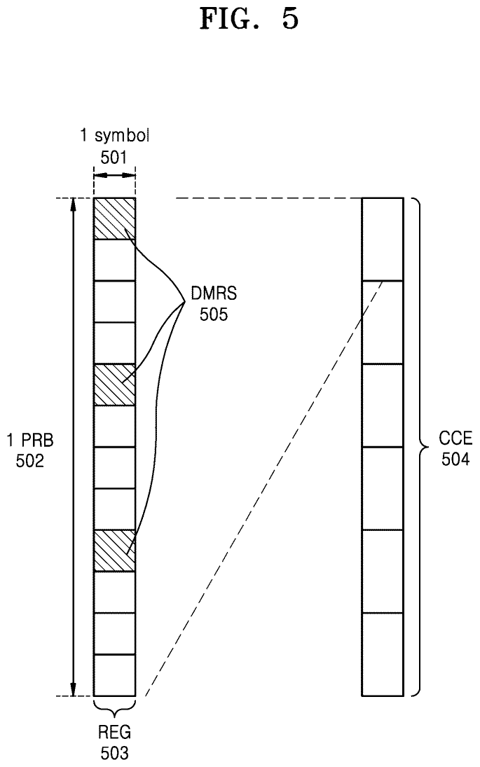

When one or more BWPs are configured in the UE, the BS may indicate change (or switch or transition) of a BWP to the UE by using a BWP indicator field in the DCI. For example, when a currently activated BWP of the UE is the BWP #1 301 in FIG. 5, the BS may indicate the BWP #2 302 to the UE through the BWP indicator in the DCI, and the UE may change the BWP to the BWP #2 302 indicated by the BWP indicator in the received DCI.

Because a DCI-based BWP change may be indicated by DCI which schedules a PDSCH or physical uplink shared channel (PUSCH), as described above, when a request for BWP change is received, the UE must be able to perform reception or transmission of a PDSCH or PUSCH scheduled by the DCI in the changed BWP without difficulty. To this end, requirements for a latency T_{BWP} required for a BWP change are specified in a standard, and may be defined, for example, as in Table 3.

TABLE 3

| | |
|---|---|
| NR Slot length | BWP switch delay T_{BWP} (slots) |

| μ | (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
Note 2:
If the BWP switch involves changing of SCS, the BWP switch delay is determined by the larger one between the SCS before BWP switch and the SCS after BWP switch.

The requirements for the BWP change latency support Type 1 and Type 2 according to capability of the UE. The UE may report a supportable BWP latency type to the BS.

According to requirements for a BWP change latency, when a UE receives DCI including a BWP change indicator in a slot n, the UE may complete changing to a new BWP indicated by the BWP change indicator no later than a slot n+T_{BWP}, and may transmit and receive a data channel scheduled by the DCI in the new BWP. When a BS is to schedule a data channel to the new BWP, the BS may determine time domain resource assignment for the data channel by considering a BWP change latency T_{BWP} of the UE. For example, as for a method of determining time domain resource assignment for a data channel, the BS may schedule the data channel after the BWP switching latency in scheduling the data channel with the new BWP. Accordingly, the UE may not expect for the DCI which indicates BWP switching to indicate a slot offset value (K0 or K2) smaller than the BWP switching latency T_{BWP}.

When the UE received the DCI indicating the BWP change (e.g., a DCI format 1_1 or 0_1), the UE may not perform any transmission or reception during a time duration from a third symbol of a slot in which a PDCCH including the DCI is received to a starting point of a slot indicated by the slot offset K0 or K2 indicated by a time domain resource assignment indicator field in the DCI. For example, when the UE has received DCI which indicates BWP switching in slot n and the slot offset value indicated by the DCI is K, the UE may not perform any transmission or reception from the third symbol of the slot n to a symbol before slot n+K, that is, the last symbol of slot n+K−1.

### [SS/PBCH Block]

Next, a synchronization signal (SS)/PBCH block in 5G is described.

The SS/PBCH block may refer to a physical layer channel block including primary SS (PSS), secondary SS (SSS), PBCH. Details are below.
PSS: a signal which serves as a reference for DL time/frequency synchronization and provides some information of the cell ID.
SSS: serves as a reference for DL time/frequency synchronization and provides the remaining cell ID not provided by PSS. In addition, SSS may serve as a reference signal for modulation of PBCH.
PBCH: provides essential system information required for transmission and reception of data channels and control channels of the UE. The essential system information may include search space-related control information representing radio resource mapping information of the control channel, scheduling control information for a separate data channel for transmitting system information, or the like.
SS/PBCH block: SS/PBCH block includes a combination of PSS, SSS, and PBCH. One or more SS/PBCH blocks may be transmitted within 5 ms, and each of the transmitted SS/PBCH blocks may be distinguished by an index.

The UE may detect PSS and SSS and decode PBCH during an initial connection stage. An MIB may be obtained from PBCH, and CORESET #0 (corresponding to a CORESET where a CORESET index is 0) may be configured therefrom. Under the assumption that the selected SS/PBCH block and a demodulation reference signal (DMRS) transmitted in CORESET #0 are quasi co located (QCL), the UE may monitor CORESET #0. The UE may receive system information through DL control information transmitted from CORESET #0. The UE may obtain, from the received system information, configuration information related to random access channel (RACH) required for initial access. The UE may transmit physical RACH (PRACH) to the BS by considering the selected SS/PBCH index, and the BS which has received the PRACH may obtain information about the SS/PBCH block index selected by the UE. The BS may identify a block selected by the UE among the respective SS/PBCH blocks and that the UE monitors CORESET #0 associated therewith.

### [PDCCH: DCI]

DCI in a 5G system will now be described below.

In a 5G system, scheduling information of UL data (or a PUSCH) or DL data (or a PDSCH) is transmitted through DCI from a BS to a UE. The UE may monitor a fallback DCI format and a non-fallback DCI format for a PUSCH or PDSCH. The fallback DCI format may include a fixed field predefined between the BS and the UE, and the non-fallback DCI format may include a configurable field.

The DCI may be channel-coded and modulated and then be transmitted through a PDCCH. Cyclic redundancy check (CRC) may be appended to a DCI message payload, and the CRC may be scrambled by a radio network temporary identifier (RNTI) which corresponds to an ID of the UE. Depending on the use of the DCI message, e.g., UE-specific data transmission, power control command, random access response, or the like, different RNTIs may be used. For example, the RNTI is not explicitly transmitted, but is included and transmitted in a CRC calculation process. On reception of a DCI message transmitted on the PDCCH, the UE may identify CRC using an assigned RNTI, and determine that the DCI message is transmitted to the UE when the CRC identification result is correct.

For example, DCI for scheduling a PDSCH for system information (SI) may be scrambled by a system information RNTI (SI-RNTI). DCI for scheduling a PDSCH for a random access response (RAR) message may be scrambled by a random access RNTI (RA-RNTI). DCI for scheduling a PDSCH for a paging message may be scrambled by a paging RNTI (P-RNTI). DCI for notifying a slot format indicator (SFI) may be scrambled by a SFI-RNTI. DCI for notifying transmit power control (TPC) may be scrambled by a TPC-RNTI. DCI for scheduling a UE-specific PDSCH or PUSCH may be scrambled by a Cell RNTI (C-RNTI).

DCI format 0_0 may be used as fallback DCI for scheduling a PUSCH, and CRC in this case may be scrambled by a C-RNTI. DCI format 0_0 obtained by scrambling the CRC by the C-RNTI may include, for example, information in Table 4.

TABLE 4

| - | Identifier for DCI formats - [1] bit |
|---|---|
| - | Frequency domain resource assignment - [ |
| ┌log₂(N_{RB}^{UL,BWP}(N_{RB}^{UL,BWP} + 1)/2)┐] bits | |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL indicator - 0 or 1 bit |

DCI format 0_1 may be used as non-fallback DCI for scheduling a PUSCH, and CRC in this case may be scrambled by a C-RNTI. DCI format 0_1 obtained by scrambling the CRC by the C-RNTI may include, for example, information in Table 5.

```
TABLE 5
  Carrier indicator - 0 or 3 bits
  UL/SUL indicator - 0 or 1 bit
  Identifier for DCI formats - [1] bits
  Bandwidth part indicator- 0, 1 or 2 bits
  Frequency domain resource assignment
    $For resource assignment type 0 , ⌈ {N}_{R B}^{U L , BWP} / P ⌉ bits$
    $For resource asssignment type 1 , ⌈ {log}_{2} ( {N}_{R B}^{U L , BWP} ( {N}_{R B}^{U L , BWP} + 1 ) / 2 ) ⌉$
    bits
  Time domain resource assignment - 1, 2, 3, or 4 bits
  VRB-to-PRB mapping - 0 or 1 bit, only for resource assignment type 1.
    0 bit if only resource assignment type 0 is configured;
    1 bit otherwise.
  Frequency hopping flag - 0 or 1 bit, only for resource assignment type
  1.
    0 bit if only resource assignment type 0 is configured;
    1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
    1 bit for semistatic HARQ-ACK codebook;
    2 bits for dynamic HARQ-ACK codebook with single HARQ-ACK
    codebook.
  2nd downlink assignment index - 0 or 2 bits
    2 bits for dynamic HARQ-ACK codebook with two HARQ-ACK
    sub-codebooks;
    0 bit otherwise.
  TPC command for scheduled PUSCH - 2 bits
  $SRS resource indicator - ⌈ {log}_{2} ( {\sum }_{k = 1}^{{L}_{max} \sum } ( \begin{matrix}{N}_{S R S} \\ k\end{matrix} ) ) ⌉ or ⌈ {log}_{2} ( {N}_{S R S} ) ⌉ bits$
    $⌈ {log}_{2} ( {\sum }_{k = 1}^{{L}_{max} \sum } ( \begin{matrix}{N}_{S R S} \\ k\end{matrix} ) ) ⌉ bits for non ‐ codebook based PUSCH$
    transmission;
    ┌log₂(N_{SRS}┐ bits for codebook based PUSCH transmission.
  Precoding information and number of layers - up to 6 bits
  Antenna ports - up to 5 bits
  SRS request - 2 bits
  CSI request - 0, 1, 2, 3, 4, 5, or 6 bits
  CBG transmission information - 0, 2, 4, 6, or 8 bits
  PTRS-DMRS association - 0 or 2 bits.
  beta_offset indicator - 0 or 2 bits
  DMRS sequence initialization - 0 or 1 bit
```

DCI format 1_0 may be used as fallback DCI for scheduling a PDSCH, and CRC in this case may be scrambled by a C-RNTI. DCI format 1_0 obtained by scrambling the CRC by the C-RNTI may include, for example, information in Table 6.

```
TABLE 6
  Identifier for DCI formats - [1] bit
  Frequency domain resource assignment
$[ ⌈ {log}_{2} ( {N}_{R B}^{D L , BWP} ( {N}_{R B}^{D L , BWP} + 1 ) / 2 ) ⌉ ] bits$
  Time domain resource assignment - X bits
  VRB-to-PRB mapping - 1 bit.
  Modulation and coding scheme - 5 bits
  New data indicator - 1 bit
  Redundancy version - 2 bits
  HARQ process number - 4 bits
  Downlink assignment index - 2 bits
  TPC command for scheduled PUCCH - [2] bits
  PUCCH resource indicator - 3 bits
  PDSCH-to-HARQ feedback timing indicator - [3] bits
```

DCI format 1_1 may be used as non-fallback DCI for scheduling a PDSCH, and CRC in this case may be scrambled by a C-RNTI. DCI format 1_1 obtained by scrambling the CRC by the C-RNTI may include, for example, information in Table 7.

```
TABLE 7
  Carrier indicator - 0 or 3 bits
  Identifier for DCI formats - [1] bits
  Bandwidth part indicator - 0, 1 or 2 bits
  Frequency domain resource assignment
    $For resource assignment type 0 , ⌈ {N}_{R B}^{D L , B B P} / P ⌉ bits$
    $For resource asssignment type 1 , ⌈ {log}_{2} ( {N}_{R B}^{D L , BWP} ( {N}_{R B}^{D L , BWP} + 1 ) / 2 ) ⌉$
    bits
  Time domain resource assignment - 1, 2, 3, or 4 bits
  VRB-to-PRB mapping - 0 or 1 bit, only for resource assignment type 1.
    0 bit if only resource assignment type 0 is configured;
    1 bit otherwise.
  PRB bundling size indicator - 0 or 1 bit
  Rate matching indicator - 0, 1, or 2 bits
  ZP CSIRS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

### [PDCCH: CORESET, REG, CCE, Search Space]

A DL control channel in the 5G communication system will now be described with reference to related drawings.

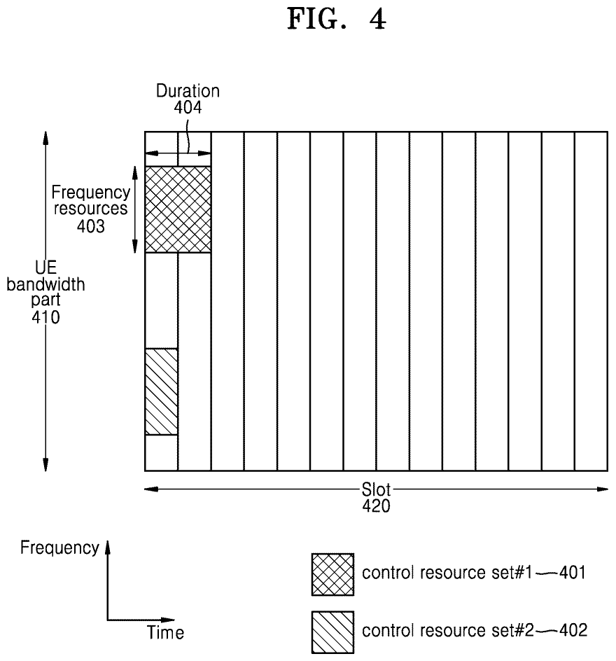

FIG. 4 is a diagram illustrating a CORESET on which a DL control channel is transmitted in a 5G wireless communication system according to an embodiment of the disclosure.

Referring to FIG. 4, a UE BWP 410 is configured on the frequency axis, and two CORESETs (CORESET #1 401 and CORESET #2 402) are configured on the time axis in a slot 420. The CORESETs 401 and 402 may be configured to a specific frequency resource 403 within the entire UE BWP 410 on the frequency domain. One or more OFDM symbols may be configured on the time axis and may be defined as a CORESET duration 404. In the example of FIG. 4, the CORESET #1 401 is configured with a CORESET duration of two symbols, and the CORESET #2 402 is configured with a CORESET duration of one symbol.

The BS may configure the CORESET of the 5G to the UE through higher-layer signaling (e.g., SI, MIB, or RRC signaling). Configuring the UE with a CORESET means providing the UE with information, such as a CORESET ID, a frequency location of the CORESET, length of symbols of the CORESET, or the like. For example, information in Table 8 below may be included.

TABLE 8

| | |
|---|---|
| ControlResourceSet ::= | SEQUENCE { |

-- Corresponds to L1 parameter ‘CORESET-ID’

| | |
|---|---|
| controlResourceSetId | , |

(CORESET identity)

| | |
|---|---|
| frequencyDomainResources | BIT STRING (SIZE |

(45)),
(Frequency axis resource assignment information)

| | |
|---|---|
| duration | INTEGER |

```
  (1..maxCoReSetDuration),
(Time axis resource assignment information)
  cce-REG-MappingType
    CHOICE {
(CCE-to-REG mapping scheme)
    interleaved
    SEQUENCE {
      reg-BundleSize
    ENUMERATED {n2, n3, n6},
(REG bundle size)
      precoderGranularity
    ENUMERATED {sameAsREG-bundle, allContiguousRBs},
      interleaverSize
    ENUMERATED {n2, n3, n6}
      (Interleaver size)
      shiftIndex
    INTEGER(0..maxNrofPhysicalResourceBlocks−1)
```

OPTIONAL

(Interleaver shift)
},

| | |
|---|---|
| nonInterleaved | NULL |

```
  },
  tci-StatesPDCCH
    SEQUENCE(SIZE (1..maxNrofTCI-StatesPDCCH)) OF TCI-StateId
```

OPTIONAL,

(QCL configuration information)

| | |
|---|---|
| tci-PresentInDCI | ENUMERATED |

{enabled}

OPTIONAL, -- Need S

}

In Table 8, tci-StatesPDCCH (simply referred to as ‘transmission configuration indication (TCI) state’) configuration information may include information about one or more SS/PBCH block indices having a QCL relation with a DMRS transmitted in the corresponding CORESET or channel state information reference signal (CSI-RS) indices.

FIG. 5 is a diagram illustrating a basic unit of time and frequency resources constituting a DL control channel which is usable in 5G according to an embodiment of the disclosure.

Referring to FIG. 5, a basic unit of time and frequency resource which forms a control channel is referred to as a resource element group (REG) 503. The REG 503 may be defined by one OFDM symbol 501 on the time axis and one physical resource block (PRB) 502, that is, 12 subcarriers on the frequency axis. The BS may configure a DL control channel assignment unit by concatenating the REG 503.

As shown in FIG. 5, when the basic unit to which the DL control channel is assigned in 5G is a control channel element (CCE) 504, one CCE 504 may include a plurality of REGs 503. In the example shown in FIG. 5, when the REG 503 includes 12 REs and one CCE 504 includes 6 REGs 503, one CCE 504 may include 72 REs. When the DL CORESET is configured, the CORESET may include a plurality of CCEs 504, and a particular DL control channel may be transmitted by being mapped to one or more CCEs 504 based on an aggregation level (AL) in the CORESET. The CCEs 504 in the CORESET may be identified by numbers. In this case, the numbers may be assigned to the CCEs 504 according to a logical mapping scheme.

The basic unit of the DL control channel shown in FIG. 5, that is, the REG 503, may include both of REs to which the DCI is mapped and regions to which a DMRS 505, which is a reference signal for decoding the same, is mapped. As shown in FIG. 5, three DMRSs 505 may be transmitted in one REG 503. The number of CCEs required to transmit a PDCCH may be 1, 2, 4, 8, or 16 depending on an AL, and the different numbers of CCEs may be used to implement link adaptation of a DL control channel. For example, when AL=L, a single DL control channel may be transmitted in L CCEs. The UE must detect a signal in a state in which the UE is not aware of information about the DL control channel. A search space representing a set of CCEs may be used for blind decoding. The search space is a set of DL control channel candidates including CCEs which the UE must attempt to decode on a given AL. Because there are various ALs which make 1, 2, 4, 8, or 16 CCEs into one bundle, the UE may have a plurality of search spaces. A search space set may be defined as a set of search spaces at all the configured ALs.

The search spaces may be classified into common search spaces and UE-specific search spaces. A certain group of UEs or all the UEs may inspect into a common search space of the PDCCH to dynamically schedule the system information or receive cell-common control information, such as a paging message. For example, PDSCH scheduling assignment information for transmitting an SIB including cell operator information or the like may be received by inspecting into the common search space of the PDCCH. For the common search space, a certain group of UEs or all the UEs need to receive the PDCCH, and thus the common search space may be defined as a set of pre-appointed CCEs. Scheduling assignment information for a UE-specific PDSCH or PUSCH may be received by monitoring a UE-specific search space of the PDCCH. The UE-specific search space may be UE-specifically defined as a function of various system parameters and an ID of the UE.

In 5G, a parameter for the search space of the PDCCH may be configured from the BS to the UE by higher-layer signaling (e.g., SIB, MIB, RRC signaling, or the like). For example, the BS may configure the number of PDCCH candidates at each AL, monitoring periodicity for the search space, monitoring occasion in symbols within the slot for the search space, a type of the search space (common search space or UE-specific search space), a combination of a DCI format to be monitored in the search space and an RNTI, a CORESET index to monitor the search space, or the like, for the UE. For example, information in Table 9 may be included.

TABLE 9

| | |
|---|---|
| SearchSpace ::= | SEQUENCE { |

```
    -- Identity of the search space. SearchSpaceId = 0 identifies the SearchSpace
    configured via PBCH (MIB) or ServingCellConfigCommon.
    searchSpaceId
    SearchSpaceId,
  (Search space identity)
    controlResourceSetId
    ControlResourceSetId,
  (CORESET identity)
```

| | |
|---|---|
| monitoringSlotPeriodicityAndOffset | CHOICE { |

```
  (Monitoring slot level period)
    sl1
    NULL,
    sl2
    INTEGER (0..1),
    sl4
    INTEGER (0..3),
    sl5
    INTEGER (0..4),
    sl8
    INTEGER (0..7),
    sl10
    INTEGER (0..9),
    sl16
    INTEGER (0..15),
    sl20
    INTEGER (0..19)
    }
```

OPTIONAL,

duration(monitoring length) INTEGER (2..2559)

| | |
|---|---|
| monitoringSymbolsWithinSlot | BIT STRING |

(SIZE (14))

OPTIONAL,

(Monitoring symbol in slot)

| | |
|---|---|
| nrofCandidates | SEQUENCE { |

```
  (Number of PDCCH candidate groups for each aggregation level)
    aggregationLevel1
    ENUMERATED {n0, n1, n2, n3, n4, n5, n6, n8},
    aggregationLevel2
    ENUMERATED {n0, n1, n2, n3, n4, n5, n6, n8},
    aggregationLevel4
    ENUMERATED {n0, n1, n2, n3, n4, n5, n6, n8},
    aggregationLevel8
    ENUMERATED {n0, n1, n2, n3, n4, n5, n6, n8},
    aggregationLevel16
    ENUMERATED {n0, n1, n2, n3, n4, n5, n6, n8}
    },
```

| | |
|---|---|
| searchSpaceType | CHOICE { |

```
    (Search space type)
    -- Configures this search space as common search space (CSS) and DCI
    formats to monitor.
    common
    SEQUENCE {
  (Common search space)
  }
    ue-Specific
    SEQUENCE {
  (UE-specific search space)
      -- Indicates whether the UE monitors in this USS for DCI
    formats 0-0 and 1-0 or for formats 0-1 and 1-1.
      formats
    ENUMERATED {formats0-0-And-1-0, formats0-1-And-1-1},
      ...
    }
```

According to the configuration information, the BS may configure one or more search space sets to the UE. In some embodiments of the disclosure, the BS may configure the UE with search space set 1 and search space set 2, configure the UE to monitor DCI format A scrambled by X-RNTI in the search space set 1 in the common search space and monitor DCI format B scrambled by Y-RNTI in the search space set 2 in the UE-specific search space.

According to the configuration information, one or more search space sets may exist in the common search space or the UE-specific search space. For example, the search space set #1 and the search space set #2 may be configured in the common search space, and search space set #3 and search space set #4 may be configured in the UE-specific search space.

In the common search space, the following combinations of DCI formats and RNTIs may be monitored. However, the UCI is not limited thereto.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. However, the UCI is not limited thereto.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Specified RNTIs may comply with the following definitions and uses.
C-RNTI (Cell RNTI): used for UE-specific PDSCH scheduling
TC-RNTI (temporary cell RNTI): used for UE-specific PDSCH scheduling

Configured scheduling RNTI (CS-RNTI): for scheduling quasi-statically configured UE-specific PDSCH
RA-RNTI (random access RNTI): used for PDSCH scheduling in a random access process
P-RNTI (paging RNTI): used for scheduling a PDSCH on which paging is transmitted
SI-RNTI (system information RNTI): used for scheduling a PDSCH on which system information is transmitted
INT-RNTI (interruption RNTI): used for indicating whether to puncture the PDSCH
TPC-PUSCH-RNTI (transmit power control for PUSCH RNTI): used for indicating power control command for a PUSCH
TPC-PUCCH-RNTI (transmit power control for PUCCH RNTI): used for indicating power control command for a PUCCH
TPC-SRS-RNTI (transmit power control for SRS RNTI): used for indicating power control command for an SRS

The aforementioned DCI formats may conform to definitions as in the examples of Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands |
| | for SRS transmissions by one or more UEs |

In 5G, with CORESET p and search space set s, a search space at aggregation level L may be expressed as in the following Equation 1:

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , m ax}^{( L )}} ⌋ + {n}_{CI} ) mod ⌊ \frac{{N}_{CCE , p}}{L} ⌋ \} + i . \qquad Equation 1$$

L: aggregation level
n_{CI}: carrier index
N_{CCE,p}: a total number of CCEs present in the CORESET p

$${n}_{s , f}^{μ} :$$

Slot index

$${M}_{s , m ax}^{( L )} :$$

a number of PDCCH candidate at aggregation level L

$${m}_{s , {n}_{CI}} = 0 , … , {M}_{s , m ax}^{( L )} - 1 :$$

Indices of PDCCH candidates at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

For common search space, a value of

$${Y}_{p , {n}_{s , f}^{μ}}$$

may correspond to 0.

The value of

$${Y}_{p , {n}_{s , f}^{μ}}$$

may correspond to a value which changes by a UE Identity (C-RNTI or ID configured by the BS for the UE) and time index for the UE-specific search space.

Because it is possible to configure a plurality of search space sets with different parameters (e.g., the parameters in Table 9) in 5G, the UE may monitor a different search space set every time. For example, when the search space set #1 is configured with X-slot periodicity and the search space set #2 is configured with Y-slot periodicity, where X and Y are different, the UE may monitor both the search space set #1 and the search space set #2 in a particular slot, and monitor one of the search space set #1 and the search space set #2 in another particular slot.

### [Rate Matching/Puncturing]

Below, a rate matching operation and a puncturing operation are described.

When a time and frequency resource A on which an arbitrary symbol sequence A is to be transmitted overlaps an arbitrary time and frequency resource B, a rate matching or puncturing operation may be considered as a transmission/reception operation of channel A considering a resource C in an area where the resource A and the resource B overlap. Detailed operations may follow the following details:

### Rate Matching Operation

The BS may map the channel A with only a remaining resource region excluding resource C corresponding to an area of entire resource A on which symbol sequence A is to be transmitted to the UE, the area overlapping resource B, and may transmit the same. For example, when the symbol sequence A is configured as {symbol #1, symbol #2, symbol #3, symbol #4}, the resource A is {resource #1, resource #2, resource #3, resource #4}, and the resource B is {resource #3, resource #5}, the BS may sequentially map the symbol sequence A with {resource #1, resource #2, resource #4}, which are the remaining resources of the resource A excluding {resource #3} corresponding to the resource C, and may transmit the same. As a result, the BS may map the symbol sequence {symbol #1, symbol #2, symbol #3} with {resource #1, resource #2, resource #4}, respectively, and transmit the same.

The UE may determine the resource A and the resource B from scheduling information of the symbol sequence A received from the BS, and determine the resource C, which is an area where the resource A and the resource B overlap each other, accordingly. The UE may receive the symbol sequence A under the assumption that the symbol sequence A is mapped in the remaining area excluding the resource C from among the entire resource A. For example, when the symbol sequence A is configured as {symbol #1, symbol #2, symbol #3, symbol #4}, the resource A is {resource #1, resource #2, resource #3, resource #4}, and the resource B is {resource #3, resource #5}, the UE may receive the symbol sequence A under the assumption that the symbol sequence A is mapped with {resource #1, resource #2, resource #4}, which are the remaining resources of the resource A excluding {resource #3} corresponding to the resource C. As a result, the UE may assume that the symbol sequence {symbol #1, symbol #2, symbol #3} are transmitted and mapped with {resource #1, resource #2, resource #4}, respectively, and may perform a series of receiving operations thereafter.

### Puncturing Operation

When the resource C corresponding to an area overlapping the resource B is present among the entire resource A on which the symbol sequence A is to be transmitted to the UE, the BS may map the symbol sequence A to the entire resource A in such a way that transmission is not performed in a resource region corresponding to the resource C, and that transmission performed only in the remaining resource area of the resource A excluding the resource C. For example, when the symbol sequence A is configured as {symbol #1, symbol #2, symbol #3, symbol #4}, the resource A is {resource #1, resource #2, resource #3, resource #4}, and the resource B is {resource #3, resource #5}, the BS may map the symbol sequence A {symbol #1, symbol #2, symbol #3, symbol #4} with the resource A {resource #1, resource #2, resource #3, resource #4}, respectively, and transmit only a symbol sequence {symbol #1, symbol #2, symbol #4} corresponding to {resource #1, resource #2, resource #4}, which are the remaining resources of the resource A excluding {resource #3} corresponding to the resource C, and may not transmit {symbol #3} mapped with {resource #3} corresponding to the resource C. As a result, the BS may map the symbol sequence {symbol #1, symbol #2, symbol #4} with {resource #1, resource #2, resource #4}, respectively, and transmit the same.

The UE may determine the resource A and the resource B from scheduling information of the symbol sequence A received from the BS, and determine the resource C, which is an area where the resource A and the resource B overlap each other, accordingly. The UE may receive the symbol sequence A under the assumption that the symbol sequence A is mapped with the entire resource A but is transmitted only in the remaining area of the resource area A excluding the resource C. For example, when the symbol sequence A is configured as {symbol #1, symbol #2, symbol #3, symbol #4}, the resource A is {resource #1, resource #2, resource #3, resource #4}, and the resource B is {resource #3, resource #5}, the UE may assume that the symbol sequence A {symbol #1, symbol #2, symbol #3, symbol #4} is mapped with the resource A {resource #1, resource #2, resource #3, resource #4}, respectively, but that {symbol #3} mapped with {resource #3} corresponding to the resource C is not transmitted, and may perform reception under the assumption that the symbol sequence {symbol #1, symbol #2, symbol #4} corresponding to {resource #1, resource #2, resource #4}, which is the remaining resources of the resource A excluding {resource #3} corresponding to the resource C. As a result, the UE may assume that the symbol sequence {symbol #1, symbol #2, symbol #4} are transmitted and mapped with {resource #1, resource #2, resource #4}, respectively, and may perform a series of receiving operations thereafter.

Below, a method of configuring a rate matching resource for the purpose of rate matching in a 5G communication system is described. Rate matching denotes that an intensity of a signal is adjusted by considering an amount of resources available to transmit the signal. For example, rate matching of a data channel may denote that a data channel is not mapped with a specific time and frequency resource domain for transmission, but a size of data is adjusted accordingly.

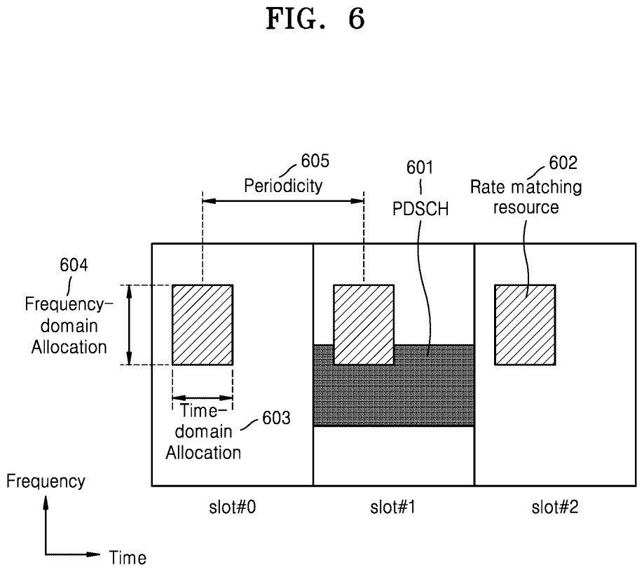

FIG. 6 is a diagram illustrating a method by which a BS and a UE transmit/receive data based on a DL data channel and a rate matching resource according to an embodiment of the disclosure.

Referring to FIG. 6, a DL data channel (PDSCH) 601 and rate matching resources 602 are shown. The BS may configure one or more rate matching resources 602 to the UE through higher-layer signaling (e.g., RRC signaling). Configuration information of the rate matching resource 602 may include time-axis resource assignment information 603, frequency-axis resource assignment information 604, and periodicity information 605. Below, a bitmap corresponding to the frequency-axis resource assignment information 604 is referred to as ‘first bit map’, a bitmap corresponding to the time-axis resource assignment information 603 is referred to ‘second bit map’, and a bitmap corresponding to the periodicity information 605 is referred to as ‘third bit map’. When all or part of time and frequency resources of the scheduled data channel 601 overlap the configured rate matching resource 602, the BS may perform rate matching on the data channel 601 in the rate matching resource 602 portion and transmit the data channel 601, and the UE may perform reception and decoding after assuming that rate matching is performed on the data channel 601 in the rate matching resource 602 portion.

The BS may dynamically notify the UE through DCI whether to perform rate matching on the data channel in the configured rate matching resource portion through additional configurations (corresponds to the ‘rate matching indicator’ within the DCI format described above). For example, the BS may select some of the configured rate matching resources and group the selected rate matching resources into a rate matching resource group, and indicate the UE as to whether the data channel for each rate matching resource group is rate-matched, by using a bitmap method through the DCI. For example, when four rate matching resources RMR #1, RMR #2, RMR #3, and RMR #4 are configured, the BS may configure RMG #1={RMR #1, RMR #2} and RMG #2={RMR #3, RMR #4} as rate matching groups, and indicate the UE by using a bitmap method as to whether rate matching is performed in RMG #1 and RMG #2. For example, when rate matching is necessary, ‘1’ may be indicated, and when rate matching is unnecessary, ‘0’ may be indicated.

In 5G, granularity of ‘RB symbol level’ and ‘RE level’ is supported by configuring the above-described rate matching resources to the UE. More particularly, the configuration method below may be followed.

### RB Symbol Level

The UE may be configured with up to four RateMatchPatterns for each BWP through higher-layer signaling, and one RateMatchPattern may include the details below.
as a reserved resource within a BWP, a resource may be included in which a time and frequency resource domain of the reserved resource is configured by combining a bitmap at an RB level with a bitmap at a symbol level along the frequency axis. The reserved resource may span one or two slots. A time domain pattern (periodicityAndPattern) may be additionally configured in which time and frequency domains including each RB level and symbol level bitmap pair are repeated.
Time and frequency domain resource regions configured as CORESETs within a BWP and resource regions corresponding to a time domain pattern configured as search space configurations in which the resource regions are repeated may be included.

### RE Level

The UE may be configured with the detail below through higher-layer signaling.
The number of ports of LTE CRS and an LTE-CRS-vshift(s) value (v-shift), location information (carrierFreqDL) of a center subcarrier of an LTE carrier from a reference frequency point (e.g., reference point A), a bandwidth size (carrierBandwidthDL) information of the LTE carrier, and subframe configuration information (mbsfn-SubframConfigList) corresponding to a Multicast-broadcast single-frequency network (MBSFN), or the like, may be included as configuration information (lte-CRS-ToMatchAround) for a resource (RE) corresponding to an LTE cell-specific reference signal or common reference signal (CRS) pattern. The UE may determine a location of the CRS in an NR slot corresponding to an LTE subframe based on the information described above.
Configuration information of a resource set corresponding to one or more zero power (ZP) CSI-RS within a BWP may be included.

### [PDSCH: Frequency Resource Assignment]

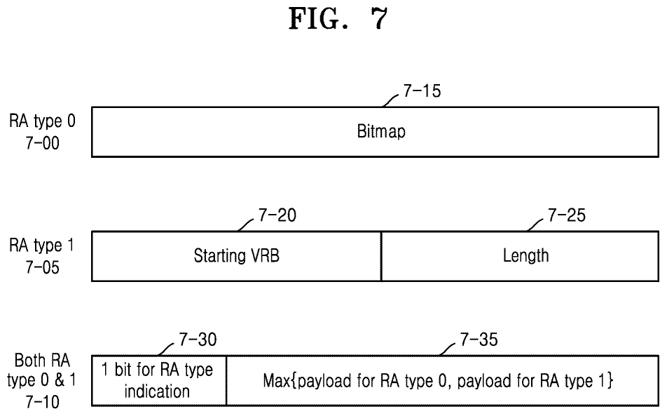

FIG. 7 is a diagram illustrating frequency axis resource assignment of a PDSCH in a wireless communication system according to an embodiment of the disclosure.

FIG. 7 is a diagram illustrating three frequency-axis resource assignment methods of type 0 7-00, type1 7-05, and dynamic switch 7-10, which are configurable through a higher layer in the NR wireless communication system.

Referring to FIG. 7, when a UE is configured to use only resource type 1 7-00 via higher-layer signaling, partial DCI assigning a PDSCH to the UE may include a bitmap consisting of N_{RBG} bits. A condition for this is described below. Here, N_{RBG} denotes the number of resource block groups (RBGs) determined as Table 11 below according to a BWP size assigned by a BWP indicator and a higher layer parameter rbg-Size, and data is transmitted to a RBG indicated by 1 by the bitmap.

TABLE 11

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

When the UE is configured to use only resource type 2 7-05 via higher-layer signaling, partial DCI assigning a PDSCH to the UE may include assignment frequency axis resource information consisting of

$$⌈ {log}_{2} ( {N}_{RB}^{DL , BWP} ( {N}_{RB}^{DL , BWP} + 1 ) / 2 ⌉$$

bits. A condition for this is described below. Accordingly, the BS may configure a starting virtual resource block (VRB) 7-20 and a length 7-25 of frequency axis resources assigned continuously therefrom.

When the UE is configured to use both resource type 0 and resource type 1 via higher-layer signaling, 7-10, partial DCI assigning PDSCH to the UE may include frequency axis resource assignment information configured of bits of a larger value 7-35 among a payload 7-15 for configuring the resource type 0 and payloads 7-20 and 7-25 for configuring the resource type 1. A condition for this is described below. At this time, one bit may be added to a front portion (most significant bit (MSB)) of the frequency axis resource assignment information in the DCI, and when the corresponding bit has a value of 0, it may be indicated that the resource type 0 is used, and when the corresponding bit has a value of 1, it may be indicated that the resource type 1 is used.

### [PDSCH/PUSCH: Time Resource Assignment]

Below, a time domain resource assignment method for a data channel in a next-generation mobile communication system (5G or NR system) is described.

A BS may configure, to a UE, a table regarding time domain resource assignment information for a PDSCH and a PUSCH, via higher-layer signaling (for example, RRC signaling). For the PDSCH, a table consisting of up to maxNrofDL-Assignments=16 entries may be configured, and for the PUSCH, a table consisting of up to maxNrofUL-Assignments=16 entries may be configured. In an embodiment of the disclosure, the time domain resource assignment information may include a PDCCH-to-PDSCH slot timing (corresponds to a time interval in a slot unit between a time point when the PDCCH is received and a time point when the PDSCH scheduled by the received PDCCH is transmitted, indicated by K0), a PDCCH-to-PUSCH slot timing (corresponds to a time interval in a slot unit between a time point when the PDCCH is received and a time point when the PUSCH scheduled by the received PDCCH is transmitted, indicated by K2), information about a location and length of a start symbol where the PDSCH or PUSCH is scheduled within a slot, and a mapping type of the PDCH or PUSCH. For example, information as shown in Table 12 or Table 13 below may be transmitted from the BS to the UE.

TABLE 12
PDSCH-TimeDomainResourceAllocationList information element

| | |
|---|---|
| PDSCH-TimeDomainResourceAllocationList ::= | SEQUENCE (SIZE (1..maxNrofDL-Allocations)) |

OF PDSCH-TimeDomainResourceAllocation

| | |
|---|---|
| PDSCH-TimeDomainResourceAllocation ::= | SEQUENCE { |

| | |
|---|---|
| k0 | INTEGER (0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(start symbol and length of PDSCH)
}

TABLE 13
PUSCH-TimeDomainResourceAllocationList information element

| | |
|---|---|
| PUSCH-TimeDomainResourceAllocationList ::= | SEQUENCE (SIZE (1..maxNrofUL-Allocations)) |

OF PUSCH-TimeDomainResourceAllocation

| PUSCH-TimeDomainResourceAllocation ::= | SEQUENCE { | |
|---|---|---|
| k2 | INTEGER (0..32) | OPTIONAL, -- Need S |

(PDCCH-to-PUSCH timing, slot unit)

| | |
|---|---|
| mappingType | ENUMERATED {typeA, typeB}, |

```
  (PUSCH mapping type)
  startSymbolAndLength INTEGER (0..127)
  (start symbol and length of PUSCH)
}
```

The BS may notify the UE of one of the entries in the table of the time domain resource assignment information, via L1 signaling (for example, DCI) (for example, indicated via a ‘time domain resource assignment’ field within DCI). The UE may obtain the time domain resource assignment information for the PDSCH or PUSCH, based on the DCI received from the BS.

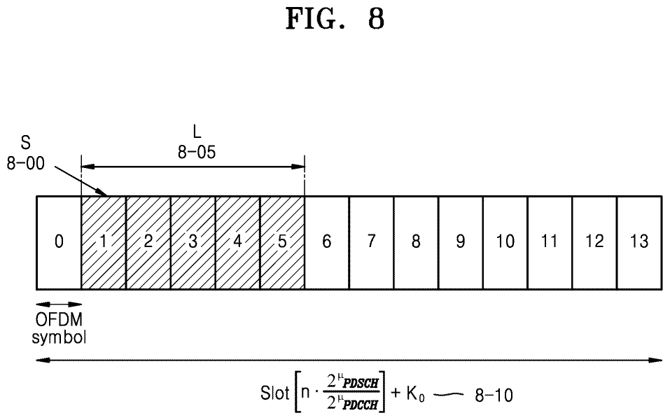

FIG. 8 is a diagram illustrating time axis resource assignment of a PDSCH in a wireless communication system according to an embodiment of the disclosure.

Referring to FIG. 8, the BS may indicate a position (μ_{PDSCH}, μ_{PDCCH}) of the time axis of a PDSCH resource according to subcarrier spacing (SCS) of a data channel and subcarrier spacing (SCS) of a control channel configured by using a higher layer, a value of a scheduling offset (K₀), and a start position 8-00 and length 8-05 of an OFDM symbol in one slot dynamically indicated through DCI.

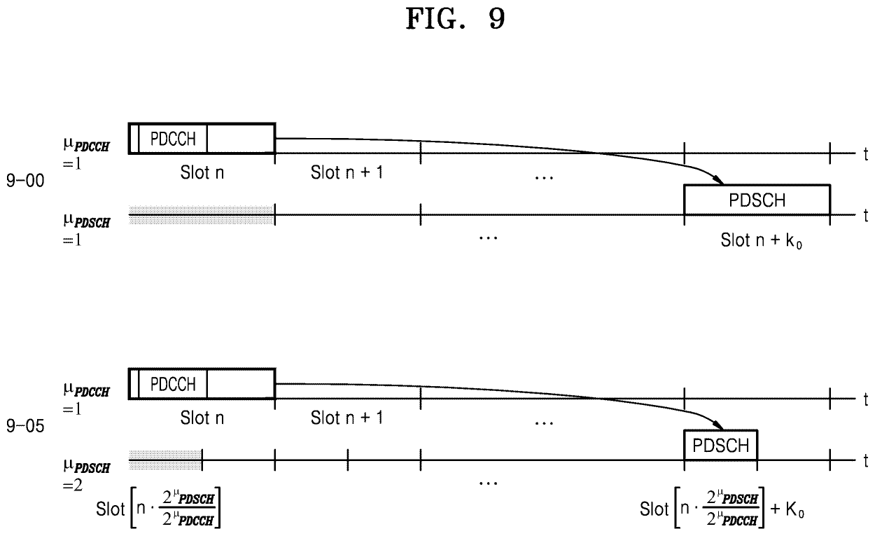

FIG. 9 is a diagram illustrating an example of time axis resource assignment according to subcarrier spacing of a data channel and a control channel in a wireless communication system, according to an embodiment of the disclosure.

Referring to FIG. 9, when the subcarrier spacing of the data channel and the subcarrier spacing of the control channel are equal (9-00) (μ_{PDSCH}=μ_{PDCCH}), slot numbers for data and control are the same, and thus, the BS and the UE may generate a scheduling offset according to a predetermined slot offset (K₀). On the other hand, when the subcarrier spacing of the data channel and the subcarrier spacing of the control channel are different (9-05) (μ_{PDSCH}≠μ_{PDCCH}), the slot numbers for data and control are different, and thus, the BS and the UE may generate a scheduling offset according to a predetermined slot offset (K₀) based on the subcarrier spacing of PDCCH.

### [PUSCH: Transmission Scheme]

A PUSCH transmission scheduling scheme will now be described.

PUSCH transmission may be dynamically scheduled by UL grant in DCI, or operated by configured grant Type 1 or Type 2. Dynamic scheduling indication for PUSCH transmission may be indicated by DCI format 0_0 or 0_1.

Configured grant Type 1 PUSCH transmission may be quasi-statically configured not by receiving UL grant in DCI but by receiving configuredGrantConfig including rrc-ConfiguredUplinkGrant of Table 14 through higher-layer signaling. Configured grant Type 2 PUSCH transmission may be semi-persistently scheduled by UL grant in DCI after reception of configuredGrantConfig which does not include rrc-ConfiguredUplinkGrant of Table 14 through higher-layer signaling. When the PUSCH transmission is operated by configured grant, parameters applied to the PUSCH transmission are applied through higher-layer signaling configuredGrantConfig of Table 14 with the exception of dataScramblingIdentityPUSCH, txConfig, codebookSubset, maxRank, scaling of UCI-OnPUSCH provided by higher-layer signaling, pusch-Config of Table 15. When the UE receives transformPrecoder in higher-layer signaling configuredGrantConfig of Table 14, the UE applies tp-pi2BPSK in pusch-Config of Table 15 for the PUSCH transmission operated by the configured grant.

```
TABLE 14
ConfiguredGrantConfig ::= SEQUENCE {
  frequencyHopping ENUMERATED {intraSlot, interSlot} OPTIONAL, -- Need S,
  cg-DMRS-Configuration DMRS-UplinkConfig,
  mcs-Table ENUMERATED {qam256, qam64LowSE} OPTIONAL, -- Need S
  mcs-TableTransformPrecoder ENUMERATED {qam256, qam64LowSE}
OPTIONAL, -- Need S
  uci-OnPUSCH SetupRelease { CG-UCI-OnPUSCH } OPTIONAL, -- Need M
  resourceAssignment ENUMERATED { resourceAssignmentType0,
resourceAssignmentType1, dynamicSwitch },
  rbg-Size ENUMERATED {config2} OPTIONAL, -- Need S
  powerControlLoopToUse ENUMERATED {n0, n1},
  p0-PUSCH-Alpha P0-PUSCH-AlphaSetId,
  transformPrecoder ENUMERATED {enabled, disabled} OPTIONAL, -- Need S
  nrofHARQ-Processes INTEGER(1..16),
  repK ENUMERATED {n1, n2, n4, n8},
  repK-RV ENUMERATED {s1-0231, s2-0303, s3-0000} OPTIONAL, -- Need R
  periodicity ENUMERATED {
  sym2, sym7, sym1x14, sym2x14, sym4x14, sym5x14, sym8x14, sym10x14,
sym16x14, sym20x14,
  sym32x14, sym40x14, sym64x14, sym80x14, sym128x14, sym 160x14,
sym256x14, sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym16x12,
sym20x12, sym32x12,
  sym40x12, sym64x12, sym80x12, sym128x12, sym160x12, sym256x12,
sym320x12, sym512x12, sym640x12,
  sym1280x12, sym2560x12
  },
  configuredGrantTimer INTEGER (1..64) OPTIONAL, -- Need R
  rrc-ConfiguredUplinkGrant SEQUENCE {
  timeDomainOffset INTEGER (0..5119),
  timeDomainAssignment INTEGER (0..15),
  frequencyDomainAssignment BIT STRING (SIZE(18)),
  antennaPort INTEGER (0..31),
  dmrs-SeqInitialization INTEGER (0..1) OPTIONAL, -- Need R
  precodingAndNumberOfLayers INTEGER (0..63),
  srs-ResourceIndicator INTEGER (0..15) OPTIONAL, -- Need R
  mcsAndTBS INTEGER (0..31),
  frequencyHoppingOffset INTEGER (1..maxNrofPhysicalResourceBlocks−1)
OPTIONAL, -- Need R
  pathlossReferenceIndex INTEGER (0..maxNrofPUSCH-PathlossReferenceRSs−1),
  ...
  } OPTIONAL, -- Need R
  ...
}
```

A PUSCH transmission method will now be described. A DMRS antenna port for PUSCH transmission is identical to an antenna port for SRS transmission. PUSCH transmission may follow a codebook based transmission method or a non-codebook based transmission method depending on whether a value of txConfig in higher-layer signaling pusch-Config of Table 15 is ‘codebook’ or ‘nonCodebook’.

As described above, PUSCH transmission may be dynamically scheduled by DCI format 0_0 or 0_1, or quasi-statically configured by the configured grant. When the UE receives an indication of scheduling of PUSCH transmission by DCI format 0_0, the UE performs beam configuration for PUSCH transmission by using pucch-spatialRelationInfoID corresponding to a UE-specific PUCCH resource corresponding to a smallest ID in an activated UL BWP in the serving cell, in which case the PUSCH transmission is based on a single antenna port. The UE does not expect scheduling for the PUSCH transmission by DCI format 0_0 in a BWP in which a PUCCH resource including pucch-spatialRelationInfo is not configured. When the UE is not configured with txConfig in the pusch-Config of Table 15, the UE does not expect to be scheduled in DCI format 0_1.

```
TABLE 15
PUSCH-Config ::= SEQUENCE {
  dataScramblingIdentityPUSCH INTEGER (0..1023) OPTIONAL, -- Need S
  txConfig ENUMERATED {codebook, nonCodebook} OPTIONAL, -- Need S
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
  pusch-PowerControl OPTIONAL, -- Need M
  frequencyHopping ENUMERATED {intraSlot, interSlot} OPTIONAL, -- Need S
  frequencyHoppingOffsetLists SEQUENCE (SIZE (1..4)) OF INTEGER (1..
maxNrofPhysicalResourceBlocks−1)
  OPTIONAL, -- Need M
  resourceAssignment ENUMERATED { resourceAssignmentType0,
resourceAssignmentType1, dynamicSwitch},
  pusch-TimeDomainAssignmentList SetupRelease { PUSCH-
TimeDomainResourceAssignmentList } OPTIONAL, -- Need M
  pusch-AggregationFactor ENUMERATED { n2, n4, n8 } OPTIONAL, -- Need S
  mcs-Table ENUMERATED {qam256, qam64LowSE} OPTIONAL, -- Need S
  mcs-TableTransformPrecoder ENUMERATED {qam256, qam64LowSE}
OPTIONAL, -- Need S
  transformPrecoder ENUMERATED {enabled, disabled} OPTIONAL, -- Need S
  codebookSubset ENUMERATED {fullyAndPartialAndNonCoherent,
partialAndNonCoherent,nonCoherent}
  OPTIONAL, -- Cond codebookBased
  maxRank INTEGER (1..4) OPTIONAL, -- Cond codebookBased
  rbg-Size ENUMERATED { config2} OPTIONAL, -- Need S
  uci-OnPUSCH SetupRelease { UCI-OnPUSCH} OPTIONAL, -- Need M
  tp-pi2BPSK ENUMERATED {enabled} OPTIONAL, -- Need S
  ...
}
```

Codebook based PUSCH transmission will now be described. Codebook based PUSCH transmission may be dynamically scheduled by DCI format 0_0 or 0_1, or quasi-statically operated by the configured grant. When the codebook based PUSCH transmission is dynamically scheduled by DCI format 0_1 or quasi-statically configured by the configured grant, the UE determines a precoder for PUSCH transmission based on an SRS resource indicator (SRI), a transmission precoding matrix indicator (TPMI), and a transmission rank (the number of PUSCH transmission layers).

The SRI may be given by a field in DCI, SRS resource indicator, or configured by higher-layer signaling srs-ResourceIndicator. The UE may be configured with at least one and up to two SRS resources for codebook based PUSCH transmission. When the UE receives the SRI in DCI, an SRS resource indicated by the SRI refers to an SRS resource corresponding to the SRI among SRS resources transmitted before the PDCCH including the SRI. Furthermore, the TPMI and the transmission rank may be given by a field in the DCI, ‘precoding information and number of layers’, or configured by higher-layer signaling precodingAndNumberOfLayers. The TPMI is used to indicate a precoder to be applied for PUSCH transmission. When the UE is configured with one SRS resource, the TPMI is used to indicate a precoder to be applied in the configured one SRS resource. When the UE is configured with a plurality of SRS resources, the TPMI is used to indicate a precoder to be applied in the SRS resource indicated by the SRI.

The precoder to be used for PUSCH transmission is selected from a UL codebook having the same number of antenna ports as a value of nrofSRS-Ports in higher-layer signaling SRS-Config. In the codebook based PUSCH transmission, the UE determines a codebook subset based on the TPMI and codebookSubset in higher-layer signaling pusch-Config. The codebookSubset in the higher-layer signaling pusch-Config may be configured as one of ‘fullyAndPartialAndNonCoherent’, ‘partialAndNonCoherent’, and ‘nonCoherent’ based on the UE capability reported by the UE to the BS. When the UE reports ‘partialAndNonCoherent’ in the UE capability, the UE does not expect that higher-layer signaling, codebookSubset is configured to have a value of ‘fullyAndPartialAndNonCoherent’. When the UE reports ‘nonCoherent’ in the UE capability, the UE does not expect that higher-layer signaling codebookSubset is configured to have a value of ‘fully AndPartialAndNonCoherent’ or ‘partialAndNonCoherent’. When nrofSRS-Ports in higher-layer signaling SRS-ResourceSet indicates two SRS antenna ports, the UE does not expect that higher-layer signaling codebookSubset is configured to have a value of ‘partialAndNonCoherent’.

The UE may be configured with one SRS resource set with a value of the usage in higher-layer signaling SRS-ResourceSet set to ‘codebook’, and one SRS resource in the SRS resource set may be indicated by the SRI. When several SRS resources in the SRS resource set with a value of the usage in higher-layer signaling SRS-ResourceSet set to ‘codebook’ are configured, the UE expects that nrofSRS-Ports in higher-layer signaling SRS-Resource is configured to have the same value for all SRS resources.

The UE transmits, to the BS, one or multiple SRS resources included in the SRS resource set with a value of the usage configured to ‘codebook’ by higher-layer signaling, and the BS selects one of the SRS resources transmitted from the UE and indicates that the UE is allowed to perform PUSCH transmission using transmit beam information of the SRS resource. In this case, for the codebook based PUSCH transmission, the SRI is used as information for selecting an index of the one SRS resource and included in DCI. In addition, the BS may add information indicating a TPMI and a rank to be used by the UE for PUSCH transmission to the DCI. The UE uses the SRS resource indicated by the SRI to perform PUSCH transmission by applying the precoder indicated by the rank and the TPMI indicated based on the transmit beam of the SRS resource.

Non-codebook based PUSCH transmission will now be described. Non-codebook based PUSCH transmission may be dynamically scheduled by DCI format 0_0 or 0_1, or quasi-statically operated by the configured grant. When at least one SRS resource in an SRS resource set with a value of the usage in higher-layer signaling SRS-ResourceSet set to ‘nonCodebook’ is configured, the UE may be scheduled for non-codebook based PUSCH transmission by DCI format 0_1.

For the SRS resource set with a value of the usage in higher-layer signaling SRS-ResourceSet configured to ‘nonCodebook’, the UE may be configured with one associated non-zero power CSI-RS (NZP CSI-RS) resource. The UE may perform calculation on a precoder for SRS transmission by measuring the NZP CSI-RS resource associated with the SRS resource set. When a gap between the last reception symbol of an aperiodic NZP CSI-RS resource associated with the SRS resource set and the first symbol of aperiodic SRS transmission from the UE is less than 42 symbols, the UE does not expect updating of information about the precoder for SRS transmission.

When a value of resourceType in higher-layer signaling SRS-ResourceSet is configured to ‘aperiodic’, an associated NZP CSI-RS is indicated in the field SRS request in DCI format 0_1 or 1_1. In this case, when the associated NZP CSI-RS resource is an aperiodic NZP CSI-RS resource, it indicates that there is an NZP CSI-RS associated for an occasion when the value of the field SRS request in DCI format 0_1 or 1_1 is not ‘00’. In this case, the DCI is prevented from indicating cross carrier or cross BWP scheduling. Furthermore, when the value of the SRS request indicates the presence of an NZP CSI-RS, the NZP CSI-RS is located in a slot in which a PDCCH including the SRS request field is transmitted. In this case, TCI states configured for a scheduled subcarrier are not configured to QCL-TypeD.

When a periodic or semi-persistent SRS resource set is configured, an associated NZP CSI-RS may be indicated by associatedCSI-RS in higher-layer signaling SRS-ResourceSet. For non-codebook based transmission, the UE does not expect both the higher-layer signaling spatialRelationInfo for an SRS resource and associatedCSI-RS in the higher-layer signaling SRS-ResourceSet to be configured.

When configured with a plurality of SRS resources, the UE may determine a precoder and a transmission rank to be applied for PUSCH transmission based on the SRI indicated by the BS. In this case, the SRI may be indicated by a field in DCI, SRS resource indicator, or configured by higher-layer signaling srs-ResourceIndicator. Similar to the aforementioned codebook based PUSCH transmission, when the UE receives the SRI in DCI, an SRS resource indicated by the SRI refers to an SRS resource corresponding to the SRI among SRS resources transmitted before the PDCCH including the SRI. The UE may use one or more SRS resources for SRS transmission, and the maximum number of SRS resources available for simultaneous transmission in the same symbol in one SRS resource set and the maximum number of SRS resources are determined by UE capability reported by the UE to the BS. In this case, the SRS resources transmitted simultaneously by the UE occupy the same RB. The UE configures one SRS port for each SRS resource. Only one SRS resource set with a value of the usage in the higher-layer signaling SRS-ResourceSet configured to ‘nonCodebook’ may be configured, and it is possible to configure up to four SRS resources for non-codebook based PUSCH transmission.

The BS transmits one NZP-CSI-RS associated with the SRS resource set to the UE, and the UE calculates a precoder to be used for transmission of one or more SRS resources in the SRS resource set based on a result of measurement during the NZP_CSI-RS reception. The UE may apply the precoder calculated to transmit one or more SRS resources in the SRS resource set with the usage configured to ‘nonCodebook’ to the BS, and the BS selects one or more of the received SRS resources. In this case, for the non-codebook based PUSCH transmission, the SRI indicates an index which may represent a combination of one or more SRS resources, and the SRI is included in DCI. The number of SRS resources indicated by the SRI transmitted from the BS may be the number of transmission layers of the PUSCH, and the UE transmits the PUSCH by applying the precoder applied for SRS resource transmission for each layer.

### [DRX]

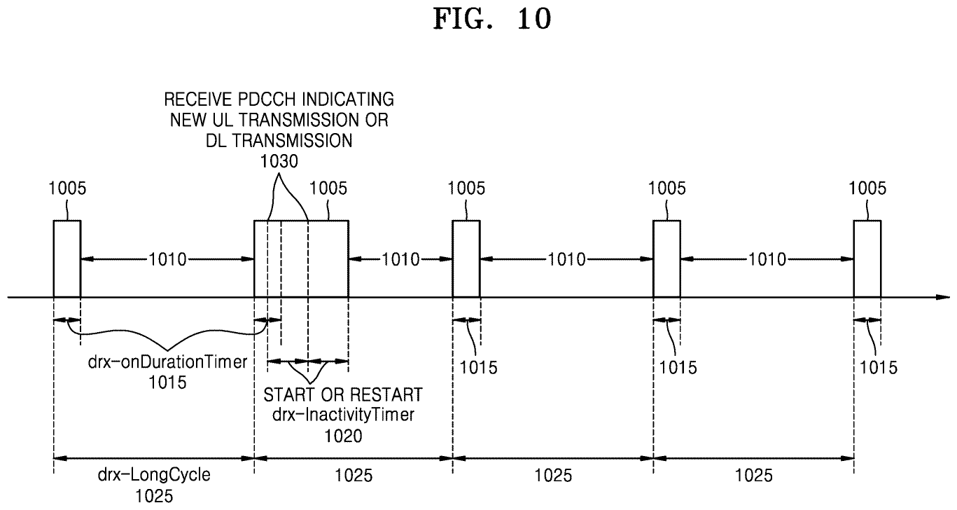

FIG. 10 is a diagram illustrating discontinuous reception (DRX) in a 5G communication system according to an embodiment of the disclosure.

DRX is an operation in which a UE using a service discontinuously receives data in an RRC connected state where a wireless link is configured between the BS and the UE. When DRX is applied, the UE turns on a receiver at a particular point and monitors a control channel, and when no data is received for a predetermined period, turns off the receiver to reduce power consumption of the UE. The DRX operation may be controlled by an MAC layer device based on various parameters and timers.

Referring to FIG. 10, an Active time 1005 is a time when the UE wakes up every DRX cycle and monitors PDCCH. The Active time 1005 may be defined as follows:
drx-onDuration Timer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble

drx-onDurationTimer, drx-InactivityTimer, drx-RetransmissionTimerDL, drx-RetransmissionTimerUL, ra-ContentionResolutionTimer, or the like, are timers of which the values are configured by the BS, and may include a function to configure the UE to monitor PDCCH in a situation where a certain condition is met.

drx-onDurationTimer 1015 is a parameter for configuring a minimum time for which the UE stays awake in the DRX cycle. drx-InactivityTimer 1020 may be a parameter for configuring an additional time for which the UE stays awake, when PDCCH for indicating new UL transmission or DL transmission is received 1030. drx-RetransmissionTimerDL is a parameter for configuring a maximum time for which the UE stays awake to receive DL retransmission in a DL Hybrid Automatic Repeat and request (HARQ) procedure. drx-RetransmissionTimerUL may be a parameter for configuring a maximum time for which the UE stays awake to receive grant of UL retransmission in an UL HARQ procedure. drx-onDurationTimer, drx-InactivityTimer, drx-RetransmissionTimerDL and drx-RetransmissionTimerUL may be configured to, for example, time, number of subframes, or number of slots. ra-ContentionResolutionTimer may be a parameter for monitoring PDCCH in a random access procedure.

inActive time 1010 may be a time configured to not monitor PDCCH during the DRX operation or a time configured to not receive PDCCH, and the remaining time excluding the Active time 1005 in the entire period during which the DRX operation is performed may be the inActive time 1010. When PDCCH is not monitored during the Active time 1005, the UE may enter sleep or inActive state so that power consumption may be reduced.

The DRX cycle may refer to periodicity during which the UE wakes up and monitors PDCCH. For example, the DRX cycle may refer to a time interval or on duration occurrence periodicity after the UE monitors PDCCH and then monitors the next PDCCH. There are two types of DRX cycles: short DRX cycle and long DRX cycle. The short DRX cycle may be applied optionally.

The long DRX cycle 1025 may be a longer cycle among two DRX cycles configured in the UE. The UE may, while operating in long DRX, restart the drx-onDurationTimer 1015 at a point when the long DRX cycle 1025 has elapsed from a starting point (e.g., start symbol) of the drx-onDuration Timer 1015. The UE may, while operating in the long DRX cycle 1025, start the drx-onDurationTimer 1015 in a slot after drx-SlotOffset in a subframe satisfying Equation 2 below. Here, drx-SlotOffset may refer to a delay before the drx-onDurationTimer 1015 is started. For example, drx-SlotOffset may be configured to, for example, time or number of slots.

$$[ ( S F N \times 10 ) + subframe number ] modulo ( drx - LongCycle ) = drx - StartOffset \qquad Equation 2$$

In this case, drx-LongCycleStartOffset may include long DRX cycle 1525 and drx-StartOffset, and may be used to define a subframe to start the long DRX cycle 1025. For example, the drx-LongCycleStartOffset may be configured to time, number of subframes, or number of slots.

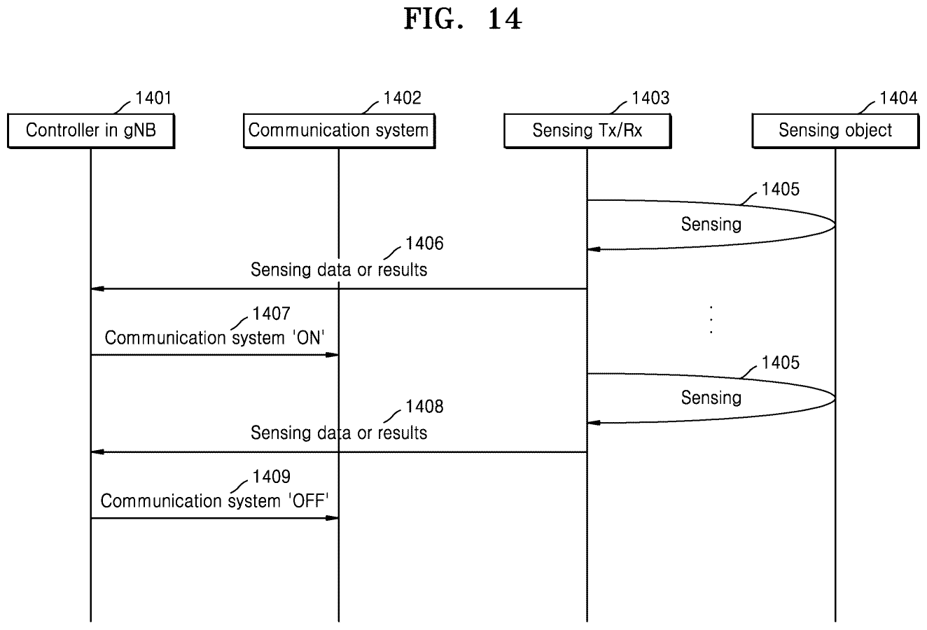

The short DRX cycle may be a shorter cycle of the two DRX cycles defined in the UE. The UE may start or restart the drx-InactivityTimer 1020 when a certain event occurs in the Active time 1005, for example, when PDCCH indicating new UL transmission or DL transmission is received 1030, and the UE may operate in a short DRX cycle when the drx-Inactivity Timer 1020 has expired or a DRX command MAC CE is received. For example, in FIG. 14, the UE may start drx-ShortCycleTimer at an expiration point of the previous drx-onDurationTimer 1015 or drx-Inactivity Timer 1020, and operate in a short DRX cycle until drx-ShortCycleTimer expires. When PDCCH indicating new UL transmission or DL transmission is received 1030, the UE may anticipate additional UL transmission or DL transmission in the future and extend the Active time 1005 or delay the arrival of the InActive time 1010. While the UE is operating in short DRX, the drx-onDurationTimer 1015 may be started again at a time point when the number of short DRX cycles has elapsed from a start point of the previous on duration. Thereafter, when drx-ShortCycleTimer has expired, the UE may operate in the long DRX cycle 1025 again.

When the UE operates in short DRX cycle, the UE may start the drx-onDurationTimer 1015 after drx-SlotOffset in a subframe satisfying Equation3 below. Here, drx-SlotOffset refers to a delay before the drx-onDurationTimer 1015 is started. For example, drx-SlotOffset may be configured to time, number of slots, or the like.

$$[ ( S F N \times 10 ) + subframe number ] modulo ( drx - ShortCycle ) = ( drx - StartOffset ) modulo ( drx - ShortCycle ) \qquad Equation 3$$

Here, drx-ShortCycle and drx-StartOffset may be used to define a subframe where the short DRX cycle is to start. drx-ShortCycle and drx-StartOffset may be configured to, for example, time, number of subframes, number of slots, or the like.

The DRX operation is described above with reference to FIG. 10. According to an embodiment of the disclosure, the UE may perform a DRX operation to reduce power consumption of the UE.

In a 5G system, a new state of UE called RRC_INACTIVE is defined to reduce time and energy consumed for initial access of the UE. In addition to operations performed by an RRC_IDLE UE, the RRC_INACTIVE UE may perform the process described below. However, the disclosure is not limited to the examples below.
Storage of access stratum (AS) information required for cell connection
UE-specific DRX cycle operation configured by RRC layer
Configuring and periodically updating a radio access network (RAN)-based notification area (RNA) which may be used during handover by RRC layer
Monitoring RAN-based paging messages transmitted via inactive-radio network temporary identifier (I-RNTI)

The UE in the RRC_CONNECTED state may receive an RRC Release indication from the BS and change from RRC-CONNECTED to an RRC_INACTIVE or RRC_IDLE state.

The UE in the RRC_INACTIVE or RRC_IDLE state may perform random access, complete all random access procedures, and change from RRC_INACTIVE or RRC_IDLE to the RRC_CONNECTED state.

The RRC_IDLE/RRC_INACTIVE UE may perform the DRX operation described above and receive a paging message. The UE may monitor one Paging Occasion (PO) during an DRX cycle. PO may be a set of PDCCH monitoring occasions, and may include a plurality of time slots (or subframes, or OFDM symbols) during which paging control information may be transmitted and received. A Paging Frame (PF) may be one radio frame (10 ms), and may include one or more POs or starting points (e.g., offsets) of POs.

PF and PO may be determined by the formulas described below.

A system frame number (SFN) for PF may be determined by (SFN+PF_offset) mod T=(T div N)*(UE_ID mod N), where PF_offset is an offset for determining PF, T is a DRX cycle, N is the number of PFs per DRX cycle (e.g., cell-common or cell-specific), which may be determined by a higher signal, such as system information, and UE_ID is a UE ID (e.g., 5G-S-TMSI), which may be determined by a core network.

PFs determined by N may refer to paging frames which are commonly applied to UEs within a cell, and may be referred to as cell-common PFs for convenience hereinafter.

i_s indicating a PO index may be determined by i_s=floor (UE_ID/N) mod Ns, where Ns may refer to the number of POs in one PF, which may be determined by a higher signal, such as system information.

For example, PF_offset=3, T=128, N=T/4=32, and Ns=4, and when it is assumed that UE_ID mod 32 is UE_ID where floor (UE_ID/32) mod 4 is 1, values of parameters may be determined by the equation below.

$$( S F N + 3 ) mod 128 = ( 128 div 32 ) * ( UE\_ID mod 32 ) = 4 * 1 = 4 , \\ i\_s = floor ( UE\_ID / 32 ) mod 4 = 1$$

Accordingly, PF, which is a paging frame to be received by the UE having the UE_ID described above, may be determined to be a radio frame having SFN of 1, 129, 257, . . . among the cell-common PFs, and PO may be determined to be an (i_s+1)^{th} PO among four POs within PF.

Below, reception of paging early indication (PEI) is described. To reduce UE power consumed while monitoring and receiving paging control channels and paging data channels in each DRX cycle, the UE may receive PEI.

According to various embodiments of the disclosure, the UE may monitor or receive one PEI occasion (PEI-O) before receiving paging during a DRX cycle. When the UE receives PEI, and the PEI indicates a subgroup to which the UE belongs, and PO, the UE belonging to the subgroup may monitor the associated PO. When the UE does not detect PEI in a PEI-O or the PEI does not indicate a subgroup to which the UE belongs, and PO, the UE does not need to monitor the associated PO, thereby reducing UE power consumption.

The UE may determine the PEI-O as below. The PEI-O may be offset by a subframe from a radio frame of a reference point which is offset by pei-FrameOffset from a PF including the associated PO. The UE may monitor PEI in a PEI-O determined by the method described above. Here, pei-FrameOffset, subframe offset, or the like, may be determined by a higher signal, such as system information.

### [LP-WUS/WUR]

To identify whether there is any data to receive, a 5G UE may need to periodically wake up once per DRX cycle, which may cause unwanted power consumption during periods when there is no signaling or data traffic. To address this issue, when the UE could wake up only when the UE needs to be activated, such as when there is data to be received by the UE, such as paging information, power consumption could be drastically reduced. This may be achieved by monitoring a wake-up signal (WUS) by using a wake-up receive (WUR) capable of monitoring WUS at ultra-low power so that a Main radio (may be understood as a signal transmission/reception device capable of performing data communication using an existing NR radio device or cellular communication) is turned on (or triggered) only when data transmission/reception is required.

For example, when the BS transmits WUS corresponding to ON or OFF to the UE, the UE on which WUR is mounted may receive the WUS by using WUR. Here, WUR may be a low-power WUR. According to whether the received signal is ON or OFF information, the UE may trigger the Main radio in the OFF or ON state to configure the main radio to be in a wake-up or power-off state. In some cases, the UE may not completely turn off the Main radio and may configure the Main radio to be in a deep sleep state where most of components of the Main radio are turned off and only essential components, such as an internal clock and memory, are operated.

When data traffic to be transmitted from the BS to the UE occurs and WUS corresponding to ON is transmitted from the BS to the UE, the Main radio may enter an ON state, and the UE may receive data to be transmitted by the BS through the main radio, not WUR.

### [NES]

As described above, in order to achieve ultra-high-speed data services reaching several Gbps, the 5G system supports ultra-wide bandwidth signal transmission and reception or utilizes spatial multiplexing methods using a plurality of transmission/reception antennas, while supporting various power saving modes to reduce power consumption of the UE. On the other hand, excessive power consumption may also occur at the BS. For example, the number of power amplifiers (PA) required increases in proportion to the number of transmission antennas provided in the BS or UE. The maximum output of the BS and UE depends on characteristics of the PA, and in general, the maximum output of the BS varies depending on the size of a cell covered by the BS. As an example of a commercial 5G BS, the BS may have 64 transmission antennas and corresponding 64 PAs in the 3.5 GHz frequency band and operate with a bandwidth of 100 MHz. Ultimately, the energy consumption of the BS increases in proportion to the output of the PA and the operating time of the PA. More particularly, a 5G BS have a relatively high operating frequency band compared to LTE, and thus has a wide bandwidth and many transmission antennas. These features have an effect of increasing data rates, but BS energy consumption increases. Therefore, the more BS there are in a mobile communications network, the greater the energy consumption of the entire mobile communications network in proportion thereto. As described above, the energy consumption of a BS largely depends on the operation of the PA. Because PA is involved in a transmission operation of BS, a DL transmission of BS is closely related to the energy consumption of BS.

From the perspective of BS energy saving, when the BS stops DL transmission operation, the PA operation is stopped accordingly, which increases the BS energy saving effect, and the operation of the remaining BS devices, such as the baseband device as well as the PA, is also reduced, enabling additional energy saving.

The DL transmission operation of BS basically depends on an amount of DL traffic. For example, when there is no data to transmit to the UE via DL, BS does not need to transmit PDSCH or PDCCH for scheduling the PDSCH. Alternatively, when the transmission may be temporarily delayed for reasons, such as the data being insensitive to transmission delay, BS may not transmit the PDSCH or/and PDCCH.

On the other hand, physical channels and physical signals, such as PSS, SSS, PBCH, and CSI-RS, have the characteristic of being transmitted repeatedly at certain promised periodicity regardless of data transmission to UE. Therefore, even when the UE does not receive data, the UE may continuously update DL time/frequency synchronization, DL channel state, radio link quality, or the like. For example, the above PSS, SSS, PBCH, and CSI-RS must be transmitted via DL regardless of DL data traffic, which may cause BS energy consumption. Therefore, BS energy savings may be achieved by adjusting transmission of PSS, SSS, PBCH, and CSI-RS signals which are unrelated to (or have low relevance to) data traffic to occur less frequently. Meanwhile, signals unrelated to (or with low relevance to) data traffic are not limited to the PSS, SSS, PBCH, and CSI-RS.

According to an embodiment of the disclosure, the energy saving effect of BS may be maximized by stopping or minimizing the operation of the PA of the BS and the operation of related RF devices, baseband devices, or the like, during a time period when the BS does not perform DL transmission through the energy saving method described above.

In addition, according to an embodiment of the disclosure, energy consumption of BS may be reduced by switching off part of an antenna or PA of the BS. In this case, as a countermeasure to the energy saving effect of the BS, adverse effects, such as a decrease in cell coverage or throughput, may occur.

For example, when a BS having 64 transmission antennas and corresponding 64 PAs in the 3.5 GHz frequency band as described above and operating with a bandwidth of 100 MHz activates only 4 transmission antennas and 4 PAs for a certain time period and switches off the rest in order to save BS energy, the BS energy consumption during that time period may be reduced to approximately 1/16 (=4/64), but it will be difficult to achieve cell coverage and throughput assuming the existing 64 antennas and PAs due to the decrease in maximum transmission power and decrease in beamforming gain.

The BS energy saving methods described above may be reclassified into three categories. There are a BS energy saving method in the frequency domain which adjusts the size of BWP according to a traffic of the BS, a BS energy saving method in the space domain which adaptively reduces the number of antenna ports, and a BS energy saving method in the time domain which adjusts cycles of CSI-RS, SSB, and DRX. These three BS energy saving methods may be used alone or in combination depending on the characteristics of the BS, such as BS traffic or coverage, and information which changes according to an energy saving method may need to be shared/transmitted to the UE.

In addition, according to an embodiment of the disclosure, an energy saving method may be performed identically within one BS or across a plurality of BSs. When the energy saving method is performed within a one BS, only very limited energy saving gains may be achieved due to the presence of idle UEs. Therefore, when a plurality of BSs cooperate to perform BS energy saving, greater energy saving benefits may be achieved.

### [ISAC]

Meanwhile, in 3GPP, research has been conducted on NR-based integrated sensing and communication (ISAC) systems. The ISAC system is a wireless sensing technology based on radio frequency (RF) signals used by a subject of mobile communication (BS or UE) in mobile communication. For example, the ISAC system is a technology in which a transmitter transmits an RF signal, and a receiver with a sensing function receives a signal which has passed through (reflected, scattered, and transmitted) a physical object along a signal path, thereby enabling object recognition through a digital signal processing algorithm (information parameters, such as signal intensity, delay, Doppler, or angular spectrum, are evaluated). Through the above, features, such as object position, velocity, and geometric information, may be extracted and contextual information for various applications may be obtained, thereby providing new functions/services, such as object detection, object recognition (human, vehicle, animal, or aircraft), and high-precision positioning, tracking, and activity recognition. The name ‘ISAC’ may also be referred to as Joint communication and sensing (JCAS) and joint radar, communication, computation, localization, sensing (JRC2LS).

As described above, an entity of wireless sensing in the ISAC system may be the same as an entity of mobile communication. For example, the subject of wireless sensing may be a BS or UE. In the ISAC system, a sensing transmitter refers to a BS or UE which transmits a sensing signal in sensing service operation. A sensing receiver refers to a BS or UE which receives a sensing signal in sensing service operation. A sensing target refers to an object or subject to be detected by deriving characteristics of the object or subject from a sensing signal. Monostatic sensing refers to the co-existence of the sensing transmitter and sensing receiver in the BS or UE. Bistatic sensing refers to a situation where the sensing transmitter and sensing receiver are located at different BSs or UEs. Sensing signal refers to an RF signal of a 3GPP radio interface which may be used for sensing purposes.

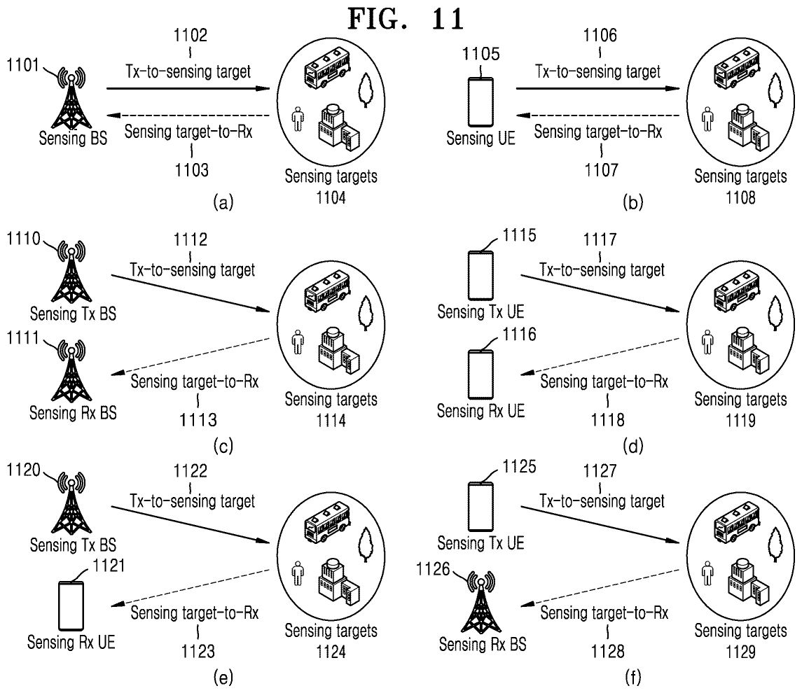

FIG. 11 is a diagram illustrating a sensing method and mode according to a sensing transmitter and a receiver of the ISAC system according to an embodiment of the disclosure.

In part (a) of FIG. 11, a BS monostatic sensing method and mode are shown in which the sensing transmitter and the receiver coexist in a BS 1101. A sensing signal 1102 may be transmitted from the sensing transmitter located at the BS 1101. The signal may reach a sensing target 1104 and experience phenomena, such as reflection, scattering, and transmission. The receiver located at the same BS as the sensing transmitter may receive the signal 1103 and detect a sensing target by using a sensing-specific algorithm.

In part (b) of FIG. 11, a UE monostatic sensing method and mode are shown in which a sensing transmitter and a receiver coexist in a UE 1105. A sensing signal 1106 may be transmitted from a sensing transmitter located at the UE 1105. The signal may reach a sensing target 1108 and experience phenomena, such as reflection, scattering, and transmission. The receiver located at the same BS as the sensing transmitter may receive the signal 1107 and detect the sensing target 1108 by using a sensing-specific algorithm.

In part (c) of FIG. 11, a BS bistatic sensing method and mode are shown in which a sensing transmitter and a receiver are located at different BSs. A sensing signal 1112 may be transmitted from a BS 1110 where the sensing transmitter is located. The signal may reach a sensing target 1114 and experience phenomena, such as reflection, scattering, and transmission. A receiver located at a different BS 1111 from the BS where the sensing transmitter is located may receive a signal 1113 and detect a sensing target through a sensing-specific algorithm.

In part (d) of FIG. 11, a UE bistatic sensing method and mode are shown in which the sensing transmitter and the receiver are located at different UEs. A sensing signal 1117 may be transmitted from a UE 1115 where the sensing transmitter is located. The signal may reach a sensing target 1119 and experience phenomena, such as reflection, scattering, and transmission. A receiver located at a different UE 1116 from the UE where the sensing transmitter is located may receive a signal 1118 and detect a sensing target through a sensing-specific algorithm.

In part (e) of FIG. 11, a BS-UE bistatic sensing method and mode are shown in which a sensing transmitter and a receiver are located at different BSs and UEs. A sensing signal 1122 may be transmitted from a BS 1120 where the sensing transmitter is located. The signal may reach a sensing target 1124 and experience phenomena, such as reflection, scattering, and transmission. Unlike the BS where the sensing transmitter is located, the receiver located at the UE 1121 may receive this signal 1123 and detect the sensing target through a sensing-specific algorithm.

In part (f) of FIG. 11, a UE-BS bistatic sensing method and mode are shown in which a sensing transmitter and a receiver are located at different UEs and BSs. A sensing signal 1127 may be transmitted from a UE 1125 where the sensing transmitter is located. The signal may reach a sensing target 1129 and experience phenomena, such as reflection, scattering, and transmission. Unlike the UE where the sensing transmitter is located, the receiver located at a BS 1126 may receive this signal 1128 and detect the sensing target through a sensing-specific algorithm.

Hereinafter, embodiments of the disclosure will be described with reference to the attached drawings. Hereinafter, a BS is an entity which performs resource assignment of a terminal, a subject which performs the role of a sensing transmitter or receiver, and may be at least one of a gNode B, a gNB, an eNode B, a Node B, a BS, a wireless access unit, a BS controller, or a node over a network. A terminal may include a user equipment (UE), a mobile station (MS), a cellular phone, a smartphone, a computer, or a multimedia system capable of performing a communication function, and may be an entity which performs the role of a sensing transmitter or receiver in an ISAC system. Although the following embodiments will focus on the 5G system as an example, they may be equally applied to other communication systems with similar technical backgrounds or channel types. For example, they may be applied to LTE or LTE-A mobile communication and future mobile communication technologies beyond 5G and 6^{th}-generation (6G). In addition, non-3GPP based sensing may be when information from non-3GPP sensors is used to determine characteristics of objects and corresponding environments. These non-3GPP sensors could include radar cameras or wireless fidelity (Wi-Fi) sensing. Although this type of sensing mechanism is not considered herein, when possible, non-3GPP sensing data of these non-3GPP sensors may be used in 5G/6G wireless sensing to obtain improved sensing results or other methods to enhance sensing services. Furthermore, embodiments of the disclosure will also be applied to other communication systems through some modifications to an extent that does not significantly deviate from the scope of the disclosure when judged by those of ordinary skill in the art. The contents of the disclosure are applicable to frequency division duplex (FDD) and time division duplex (TDD) systems.

While describing the disclosure, detailed descriptions of related functions or configurations which may blur the points of the disclosure are omitted. The terms used herein are defined based on functions used in the disclosure, and can be changed according to the intent or commonly used methods of users or operators. Accordingly, definitions of the terms are understood based on the entire descriptions of the disclosure.

In the following description, higher-layer signaling may correspond to at least one or one or more combinations of the following signaling:
Master information block (MIB)
System information block (SIB) or SIB X (X=1, 2, . . . )
Radio resource control (RRC)
Medium access control (MAC) control element (CE)

Furthermore, L1 signaling may correspond to at least one or one or more combinations of the following signaling methods using a physical layer channel or signaling:
physical downlink control channel (PDCCH)
downlink control information (DCI)
UE-specific DCI
Group common DCI
Common DCI
Scheduling DCI (e.g., DCI used for the purpose of scheduling DL or UL data)
Non-scheduling DCI (e.g., DCI used not for scheduling DL or UL data)
Physical uplink control channel (PUCCH)
Uplink control information (UCI)

Determining priorities among A and B may refer to selecting one of A and B which has a higher priority according to a preset priority rule and performing a corresponding operation or omitting or dropping an operation for the other one which has a lower priority.

Unless specifically stated otherwise, an operation of a transmission and reception point (TRP) in the disclosure below can be understood as a BS including/operating a TRP which operates based on or using the TRP.

The above examples will now be described with several embodiments of the disclosure, in which case one or more embodiments may be applied simultaneously or in combination rather than separately.

### Introduction of Embodiment

As described above, the energy saving effect of the BS may include a saving method in the frequency domain which adjusts the size of BWP according to a traffic of the BS, a BS energy saving method in the space domain which adaptively reduces the number of antenna ports, and a BS energy saving method in the time domain which adjusts cycles of CSI-RS, SSB, and DRX.

Among these, physical channels and physical signals which are repeatedly transmitted at promised periodicity regardless of data transmission may have different transmission patterns, depending on whether there is a UE within the cell. The BS may periodically transmit signals, such as CSI-RS, SSB, and DRX, assuming that there is a UE within the cell. On the other hand, when there are UEs within the cell, the BS may expect improved energy saving effects by temporarily stopping transmission of the above signals or delaying the transmission periodicity. However, the BS may need to receive a separate signal from the UE to determine whether there is a UE within the cell. This UE transmission operation may achieve energy saving effects at the BS, but may reduce the energy saving effects at the UE.

In this context, when a BS may independently identify the presence of a UE within the cell without separate communication signaling, adaptive energy saving effects can be expected.

In addition, the UE must monitor signals, such as CSI-RS, SSB, and DRX, at promised periodicities to identify DL time/frequency synchronization, channel state, and radio link quality. When the UE can independently determine whether the BS is transmitting signals, a periodic signal monitoring operation of the UE may be improved. Through this, energy saving effects of the UE can be expected.

In the embodiments below, in the ISAC system, a configuration of the ISAC system within a BS and a UE, a method of configuring sensing resources, a method of determining activation/deactivation a communication system performed by a BS using sensing information, a method of identifying the presence of a UE in a BS when performing sensing, and a method of identifying the cell status of a UE when performing sensing are described. Based on the above, energy saving effects of BSs and/or UEs can be expected by utilizing sensing information of the ISAC system.

As a basic assumption of ISAC system operation, a BS may configure sensing scheduling for transmitting sensing signals to a sensing system and monitoring sensing signals. The BS may configure cell-specific information to the UE for operation of the sensing system of the UE, and the UE may operate sensing based on the configuration information and/or indication information of the BS. In this case, similar to the BS, the UE may transmit or monitor a sensing signal.

### First Embodiment: ISAC System Configuration in BS and UE

The ISAC system may be implemented in one entity (BS or UE) by a sensing system having a sensing transmitter, a sensing receiver, and a sensing processing unit (control unit or processor) and a communication system having a communication transmitter, a communication receiver, and a communication processing unit (control unit or processor). A configuration of the ISAC system may vary depending on the sensing and communication methods implemented and operated.

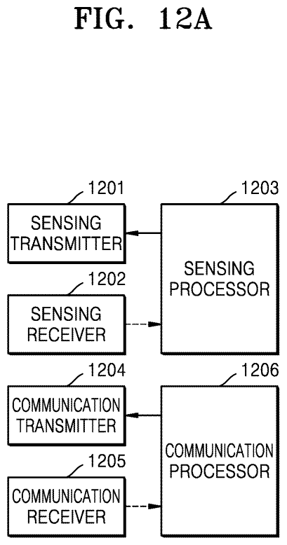

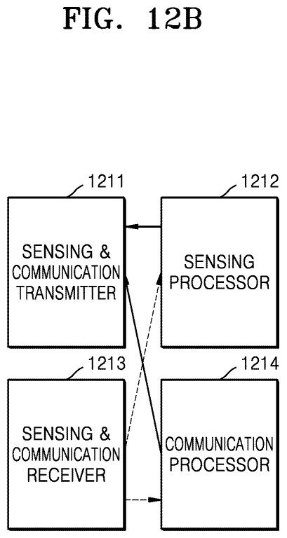

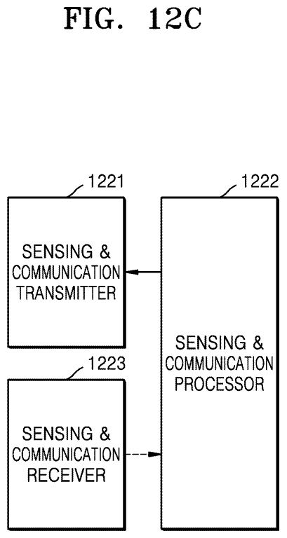

FIGS. 12A, 12B, and 12C are diagrams illustrating a configuration method of an ISAC system according to various embodiments of the disclosure.

Referring to FIG. 12A, the ISAC system may have a sensing system and a communication system configured separately. The sensing system may include a sensing transmitter 1201, a sensing receiver 1202, and a sensing processing unit 1203. For example, the sensing transmitter 1201 and the sensing receiver 1202 may perform a function of transmitting and receiving sensing signals. Here, the term ‘sensing signal’ refers to a signal intended solely for sensing. To achieve this, the sensing transmitter and the receiver may include an RF transmitter for up-converting and amplifying a frequency of a signal to be transmitted and an RF receiver for low-noise amplifying a received signal and down-converting its frequency. The sensing transmitter 1201 may transmit, via a wireless channel, a sensing signal transmitted from the sensing processing unit 1203 to an object to be sensed, and the sensing receiver 1202 may receive a signal which is reflected, scattered, or refracted and returned from the object. The sensing signal received by the sensing receiver 1202 may be transmitted to the sensing processing unit 1203. In addition, the communication system may include a communication transmitter 1204, a communication receiver 1205, and a communication processor 1206. The communication system may include a transceiver, which refers to the communication receiver 1205 and the communication transmitter 1204, memory (not shown), and a communication processing unit 1206 (or a control unit or processor). Depending on the ISAC system configuration described above, the sensing system and the communication system may have different RF transceivers. For example, there may be an RF transceiver dedicated to the sensing system and an RF transceiver dedicated to the communication system, and each of which may be connected to their own processing unit. Through this system configuration, signal transmission and reception and processing for sensing and communication may be operated independently, ensuring flexibility in system operation.

Referring to FIG. 12B, the ISAC system may have a configuration which shares some elements of the sensing system and the communication system. A transmitter of the sensing system and a transmitter 1211 of the communication system may be implemented in the same device. The transmitter refers to an RF transmitter which increases and amplifies a frequency of a signal, and may transmit a signal through a wireless channel, and thus the same device may be shared. In addition, the receiver of the sensing system and a receiver 1213 of the communication system may be implemented in the same device. Depending on the signal transmitted from the processing unit of each system, the transmitter 1211 may transmit each signal through a wireless channel. For example, when a signal is transmitted from a communication processing unit 1214 to the sensing and communication transmitter 1211, the signal can be transmitted, and when a signal is transmitted from a sensing processing unit 1212, the signal may be transmitted. The receiver is an RF receiver which amplifies the received signal with low noise and down-converts a frequency, and receives a signal transmitted through a wireless channel so that the same receiver may be shared between the sensing system and the communication system. For example, when a signal is received by the sensing and communication receiver 1213, the signal may be transmitted to the sensing processing unit 1212 and/or the communication processing unit 1214. In this case, the sensing and communication receiver 1213 may include a device capable of distinguishing between sensing signals and communication signals, and through this, the pre-classified signal may be transmitted to each processing unit appropriately. In another way, the sensing and communication receiver 1213 may not include a separate signal distinguishing device. In this case, the signal may be transmitted to the sensing processing unit 1212 and the communication processing unit 1214, and the signal may be classified and processed separately in each processing unit. This system configuration uses the same RF transceiver, thereby ensuring ease of implementation.

Referring to FIG. 12C, the ISAC system may share some elements of the sensing system and the communication system, and may also share a processing unit 1222 for processing sensing and communication signals. For example, the sensing and communication processing units may be implemented in the form of a single chip. The transmitter refers to an RF transmitter which increases and amplifies a frequency of a signal, and may transmit a signal through a wireless channel, and thus a same device 1221 may be shared. In addition, the receiver of the sensing system and a receiver 1223 of the communication system may be implemented in the same device. Depending on the signal transmitted from the processing unit of each system, the transmitter 1221 may transmit each signal through a wireless channel. For example, when a signal is transmitted from the sensing and communication processing unit 1222 to the sensing and communication transmitter 1221, the signal may be transmitted. The receiver is an RF receiver which amplifies the received signal with low noise and down-converts a frequency, and receives a signal transmitted through a wireless channel so that the same receiver may be shared between the sensing system and the communication system. For example, when a signal is received by the sensing and communication receiver 1223, the signal may be transmitted to the sensing and communication processing unit 1222. In this case, the sensing and communication receiver 1223 may include a device capable of distinguishing between sensing signals and communication signals, and through this, the pre-classified signal may be transmitted to the processing unit. In another way, the sensing and communication receiver 1223 may not include a separate signal distinguishing device. In this case, the signal may be transmitted to the sensing and communication processing unit 1222, and the signal may be classified and processed separately within the processing unit.

The ISAC system allows sensing and communication systems to coexist in one entity (BS or UE). However, this does not mean that one ISAC entity has a sensing transmitter and a sensing receiver for a sensing system. Depending on the implementation, at least one of a sensing transmitter or a sensing receiver may be implemented. For example, there may be a BS or UE in which an ISAC system having only a sensing reception function is implemented. This BS or UE do not transmit separate sensing signals and may only receive sensing signals. In another example, there may be a BS or UE in which an ISAC system having only a sensing transmission function is implemented. This BS or UE do not receive separate sensing signals and may only transmit sensing signals.

At least one of the sensing transmitter, sensing receiver, or sensing processor of the ISAC system may be implemented at a transmission point (that is, a TRP operated by a BS). In one method, the sensing transmitter and the sensing receiver may be implemented in the TRP, and the sensing processing unit may be implemented as a component of a BS operating the TRP. For example, the sensing processing unit within a BS may transmit a sensing signal to a TRP connected to the BS, and a sensing transmitter within the TRP may transmit the sensing signal. A sensing receiver within the TRP may receive a sensing signal received via a wireless channel and transmit the signal to the sensing processing unit within the BS. In another way, the entire sensing transmitter, sensing receiver, and sensing processing unit may be implemented in the TRP.

### Second Embodiment: Method of Configuring Sensing Resources

A BS supporting the ISAC system may perform cell-specific/UE-specific scheduling based on a frame structure of the existing communication system to operate the sensing system.

In a first method, in addition to the existing unpaired spectrum (or TDD) or paired spectrum (or FDD) frame structure types, another frame structure type (e.g., frame structure type 2) may be introduced to define the operation of the sensing system described above. The frame structure type 2 described above may be defined as being supported at a specific frequency or frequency band, or the BS may indicate to the UE whether the sensing system is supported, in system information. A UE supporting a sensing system may receive system information including whether the sensing system is supported, and determine whether the sensing system is supported in a specific cell (or frequency or frequency band).

In a second method, it may be indicated whether the sensing system operation is additionally supported at a specific frequency or frequency band of the existing unpaired spectrum (or TDD) without defining a new frame structure type. In the second method described above, it may be defined whether the sensing system resource configuration is additionally supported in a specific frequency or frequency band of the existing unpaired spectrum, or the BS may indicate to the UE whether the sensing system is supported, through system information. A UE supporting a sensing system may receive the system information including whether the sensing system is supported, and determine whether the sensing system is supported in a specific cell (or frequency or frequency band).

In the first and second methods described above, information on whether the sensing system is supported may be information which indirectly indicates whether the sensing system is supported by additionally configuring part of the DL resources, part of the flexible resources, or part of the UL resources as sensing system resources in addition to the configuration of TDD UL_DL resource configuration information indicating DL slot (or symbol) resources and UL slot (or symbol) resources of TDD, or may be information which directly indicates whether the sensing system is supported.

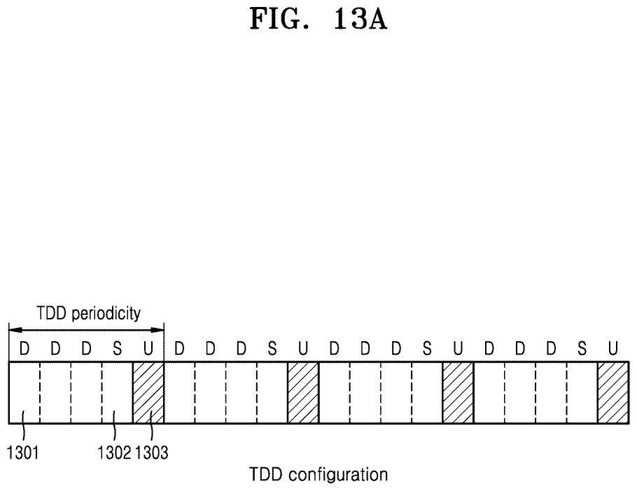

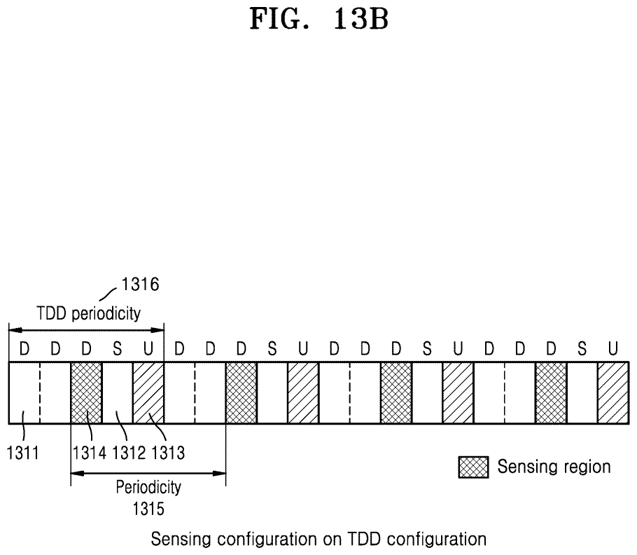

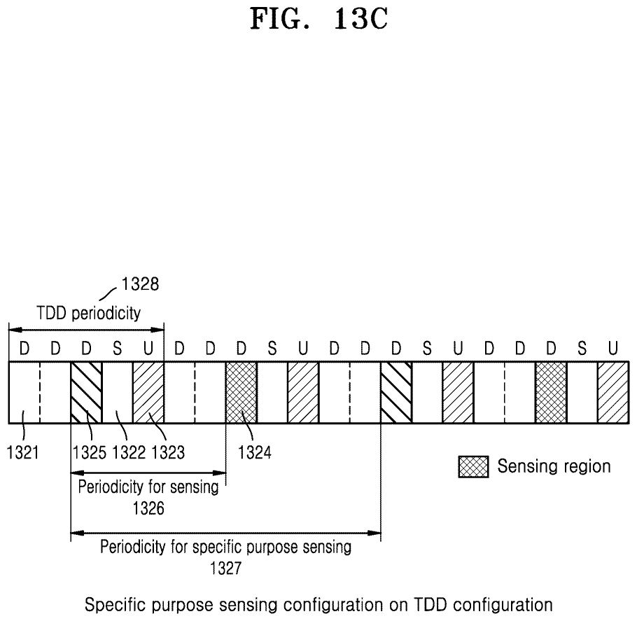

FIGS. 13A, 13B, and 13C are diagrams illustrating sensing system resources operated in a TDD band of the ISAC system, according to various embodiments of the disclosure.

FIG. 13A shows a case where TDD operates in a specific frequency band. In a cell operating the TDD described above, a BS may transmit and receive, to and from the existing TDD UE, signals including data/control information in a DL slot (or symbol), a UL slot (or symbol), and a flexible slot (or symbol) based on configurations for TDD UL-DL resource configuration information indicating DL slot (or symbol) resources and UL slot (or symbol) resources of the TDD.

Referring to FIGS. 13A, 13B, and 13C, it may be assumed that a DDDSU slot format is configured according to the TDD UL-DL resource configuration information. Here, ‘D’ is a slot consisting entirely of DL symbols, ‘U’ is a slot consisting entirely of UL symbols, and ‘S’; is a slot which is neither ‘D’ nor ‘U’, that is, a slot which includes DL symbols or UL symbols or includes flexible symbols. Here, for convenience, it may be assumed that S includes 12 DL symbols and 2 flexible symbols. And the DDDSU slot format may be repeated depending on the TDD UL-DL resource configuration information. For example, the repetition period of the TDD configuration may be 5 slots (5 ms for 15 kHz SCS, 2.5 ms for 30 kHz SCS, or the like).

Next, FIGS. 13B and 13C show a case where a sensing system on TDD is operated in a specific frequency band.

The BS may configure some of the DL resources, UL resources, or flexible resources in the TDD UL-DL resource configuration information as resources for operating the sensing system as cell-specific information. FIG. 13B shows an example in which some of DL resources among the TDD UL-DL resource configuration information are assigned as resources for operating the sensing system. According to FIG. 13B, the TDD UL-DL resource configuration may be repeated according to a TDD periodicity 1316. Sensing operation resources (slot units or symbol units) 1314 are cell-specific information and may be configured together with configuration of a periodicity 1315 configuration. With this configuration, the BS may operate the sensing system every repeating periodicity 1315.

The BS may perform separate resource configuration for sensing service-specific operation on TDD UL-DL resource configuration and cell-specific sensing system resources. FIG. 13C illustrates a resource assignment method for sensing service-specific operation on the TDD UL-DL resource configuration information and the cell-specific sensing system resources. According to FIG. 13C, the TDD UL-DL resource configuration may be repeated according to a TDD periodicity 1328. Sensing operation resources (slot units or symbol units) 1324 are cell-specific information and may be configured together with configuration of a periodicity 1326 configuration. With this configuration, the BS may operate the sensing system every repeating periodicity 1326. In addition, to operate as a specific sensing service, a sensing service-specific resource 1325 having periodicity 1327 may be separately configured on the cell-specific sensing system operation resource 1324. In this case, periodicity 1327 of the sensing service-specific resource 1325 may be greater than or equal to the periodicity 1326 of the cell-specific sensing system resource 1324.

### Third Embodiment: Method of Determining Activation/Deactivation a Communication System Performed by a BS Using Sensing Information

In the ISAC system, it may be determined whether to activate a communication system based on sensing information of the sensing system. The BS may schedule periodic sensing signal transmission and sensing signal monitoring for sensing system operation. A sensing receiver within a sensing system may monitor sensing signals according to periodicity configured by the BS, and transmit sensing results (received sensing signals) to the BS. The BS may determine a state of an area covered by each sensing system based on the received sensing signals. When the BS determines that there is no UE within the sensing system coverage area by using the received sensing signal, the BS may indicate deactivation of the communication system in that area. When the BS determines that there is a UE within the sensing system coverage area by using the received sensing signal, the BS may indicate activation of the communication system in that area.

FIG. 14 is a diagram illustrating a method of activating/deactivating a communication system, performed by a BS, using sensing information, according to an embodiment of the disclosure;

Referring to FIG. 14, a sensing transmitter and sensing receiver 1403 in the sensing system perform sensing signal transmission and sensing signal monitoring according to scheduling information configured from the BS. The sensing receiver may collect sensing signals reflected by a sensing object 1404, and the collected signals may be transmitted to the BS 1401, in operation 1406. In this case, the transmitted sensing signal may be raw data of the collected signal depending on whether a sensing system is implemented, or may be a sensing result processed for a sensing purpose (e.g., the number of UEs in a cell). The BS 1401 may determine a status of the cell based on the received sensing data or result. When the BS 1401 determines that a UE exists within the cell based on the sensing data or result, the BS 1401 may indicate activation 1407 of the communication system 1402. The communication system 1402 may provide a communication service to the UE within the cell according to the indication of the BS 1401. At the same time, the sensing transceiver may continuously monitor the status of the cell and transmit sensing data or result to the BS, in operation 1408. When the BS 1401 determines that there is no UE within the cell based on the sensing data or result, the BS may indicate deactivation to the communication system, in operation 1409. The communication system 1402 may deactivate the communication service according to the indication of the BS 1401.

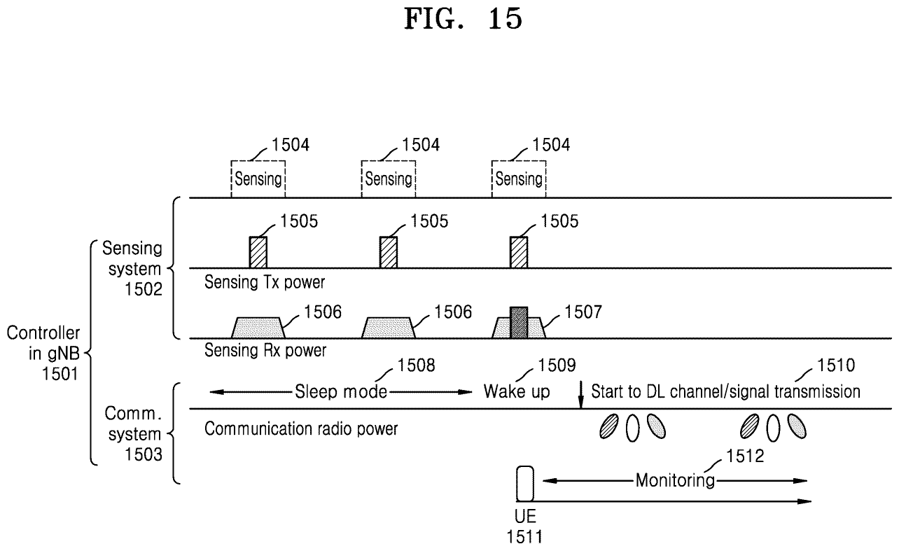

FIG. 15 is a diagram illustrating a method of activating/deactivating a communication system, performed by a BS, using sensing information, according to an embodiment of the disclosure.

Referring to FIG. 15, a sensing system 1502 and a communication system 1503 may be implemented in a TRP responsible for the same cell. The sensing system 1502 and the communication system 1503 may be connected to a BS 1501 responsible for scheduling and controlling sensing and communication. The BS 1501 may perform sensing-related resource scheduling and sensing indication for the sensing system 1502, and receive sensing data or result from the sensing system 1502. In addition, the BS 1501 may control communication-related resource scheduling and communication-related operation for the communication system 1503, and indicate activation/deactivation of the communication system 1503. The BS 1501 may schedule sensing resources for the sensing system 1502 and configure sensing signal transmission and signal monitoring. The sensing system 1502 may perform sensing 1504 according to the configuration from the BS. The sensing transmitter may transmit a sensing signal, in operation 1505, and the sensing receiver may monitor a sensing signal which is reflected, scattered, and refracted back from an object to be sensed, in operations 1506 and 1507. The sensing system 1502 may convert the received sensing signal into sensing data or result according to a format configured by the BS and transmit same to the BS 1501. In this case, the BS 1501 may identify a change pattern of the received sensing data or result. For example, when the sensing data or result is analyzed, the absence 1506 or presence 1507 of an object (e.g., a UE) within a cell may be detected. The BS 1501 may indicate whether to activate or deactivate the communication system 1503 based on the sensing data or result. When the absence 1506 of a UE 1511 within the cell is determined based on the sensing data or result, the BS 1501 may indicate deactivation to the communication system 1503, and the communication system 1503 may stop DL data/channel transmission to save energy, in operation 1508. When the BS 1501 determines the presence 1507 of the UE 1511 within the cell based on the sensing data or result, the BS 1501 may indicate activation to the communication system 1503, and the communication system 1503 may resume operation, in operation 1509, for DL data/channel transmission. Thereafter, DL data/channel transmission for cell access and data transmission of UEs may be performed in operation 1510. In this way, the communication system may be expected to have an energy-saving effect.

### Fourth Embodiment: Method of Identifying Whether a UE is Present, by a BS, when Performing Sensing

In the ISAC system, the BS may perform sensing to determine whether a UE exists within a cell, and determine whether the UE possesses a sensed object by receiving a sensing signal from the UE.

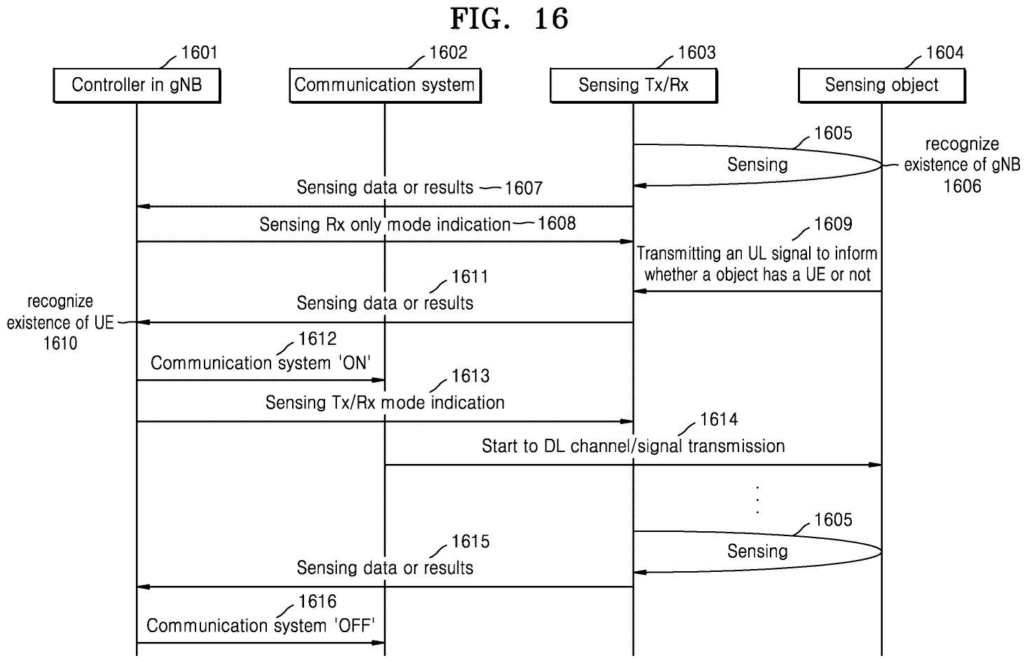

FIG. 16 is a diagram illustrating a method of determining whether a UE is present, when a BS performs sensing, according to an embodiment of the disclosure.

Referring to FIG. 16, a sensing transceiver 1603 may transmit a sensing signal according to sensing operation resource information configured from a BS, and receive, in operation 1605, a sensing signal reflected, scattered, or refracted from a specific object. In this case, the object may be a person having a UE or a person not having a UE. For a person having a UE, a UE capable of operating the sensing system may monitor the sensing signal transmitted from the sensing transceiver 1603, thereby determining whether a cell exists, in operation 1606. On the other hand, a BS 1601 may receive sensing data or result received from the sensing transceiver 1603, and thereby determine that there is a new object 1604 within the cell. When the BS 1601 determines that there is a new object 1604 in the cell, the BS may indicate, in operation 1608, the sensing transceiver 1603 to switch to a mode in which only sensing reception is possible to determine whether the object 1604 has a UE. The sensing transceiver 1603 may operate in a sensing reception mode according to the indication 1608 from the BS 1601. After receiving the indication 1608, the sensing transceiver may perform sensing signal monitoring from sensing resources preconfigured by the BS. After the UE recognizes that there is a BS in a place where the UE is located, in operation 1606, the UE may transmit, in operation 1609, a sensing signal on a sensing resource preconfigured by the BS so as to notify that the UE is a UE and not a general object. The sensing transceiver 1603 may transmit, to the BS, sensing data or result received on the resource preconfigured by the BS, in operation 1611. Through the above, the BS may recognize, in operation 1610, that the sensing data or result 1607 was previously from a UE. Based on the determination result, the BS may indicate activation to the communication system, in operation 1612. At the same time, the BS may indicate the sensing transceiver 1603 to switch from the sensing reception mode to a sensing transceiver mode to monitor the continued presence of the UE, in operation 1613. A communication system 1602 may resume the stopped DL data/channel transmission based on an activation indication from the BS, in operation 1614. Thereafter, when the BS 1601 recognizes the absence of an object within the cell based on sensing data or result 1615 received from the sensing transceiver 1603, the BS 1601 may indicate deactivation to the communication system 1602, in operation 1616. The communication system 1602, upon receiving the deactivation indication from the BS, may stop DL data/channel transmission. Through this method (a method by which a BS recognizes a UE by using only a sensing signal within a sensing system), an energy saving effect of the communication system of the BS may be expected.

In another method, in the ISAC system, the BS may perform sensing to determine whether a UE exists within a cell, and determine whether the UE possesses a sensed object by receiving a communication signal from the UE.

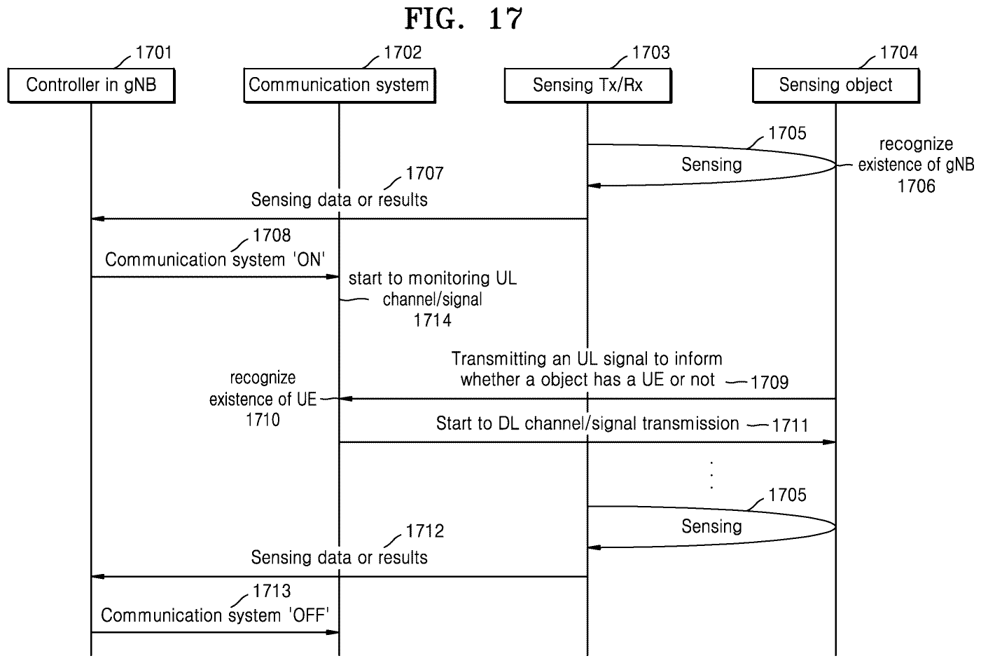

FIG. 17 is a diagram illustrating a method of determining whether a UE is present, when a BS performs sensing, according to an embodiment of the disclosure.

Referring to FIG. 17, a sensing transceiver 1703 may transmit a sensing signal according to sensing operation resource information configured from the BS, and receive, in operation 1705, a sensing signal reflected, scattered, or refracted from a specific object. In this case, the object may be a person having a UE or a person not having a UE. For a person having a UE, a UE capable of operating the sensing system may monitor the sensing signal transmitted from the sensing transceiver 1703, thereby determining whether a cell exists, in operation 1706. On the other hand, the BS may transmit, in operation 1707, sensing data or result received from the sensing transceiver 1703 to a BS 1701, thereby determining that there is a new object 1704 within the cell. The BS 1701 may indicate activation to a communication system 1702, in operation 1708. The communication system 1702, which has received the activation indication from the BS, may monitor, in operation 1714, a UL signal on a resource preconfigured by the BS to determine whether there is a UE around the cell, without immediately performing DL data/channel transmission. On the other hand, the UE may transmit a UL communication signal preconfigured by the BS to inform the BS whether the object has the UE, in operation 1709. When the communication system 1702 receives a communication signal on a UL resource preconfigured by the BS, the communication system 1702 may determine that a UE exists within the cell, in operation 1710. Based on the above, the communication system may resume DL data/channel transmission, in operation 1711. The sensing transceiver 1703 may continue the sensing operation 1705 and transmit, in operation 1712, sensing data or result to the BS 1701. Thereafter, when the BS 1701 recognizes the absence of an object within the cell based on the sensing data or result 1712 received from the sensing transceiver 1703, the BS 1701 may indicate deactivation to the communication system 1702, in operation 1713. The communication system 1702, upon receiving the deactivation indication from the BS, may stop DL data/channel transmission.

In another method, in the ISAC system, the BS may perform only the sensing reception mode to determine whether a UE exists within the cell, and perform the determination through a sensing signal transmitted from the UE.

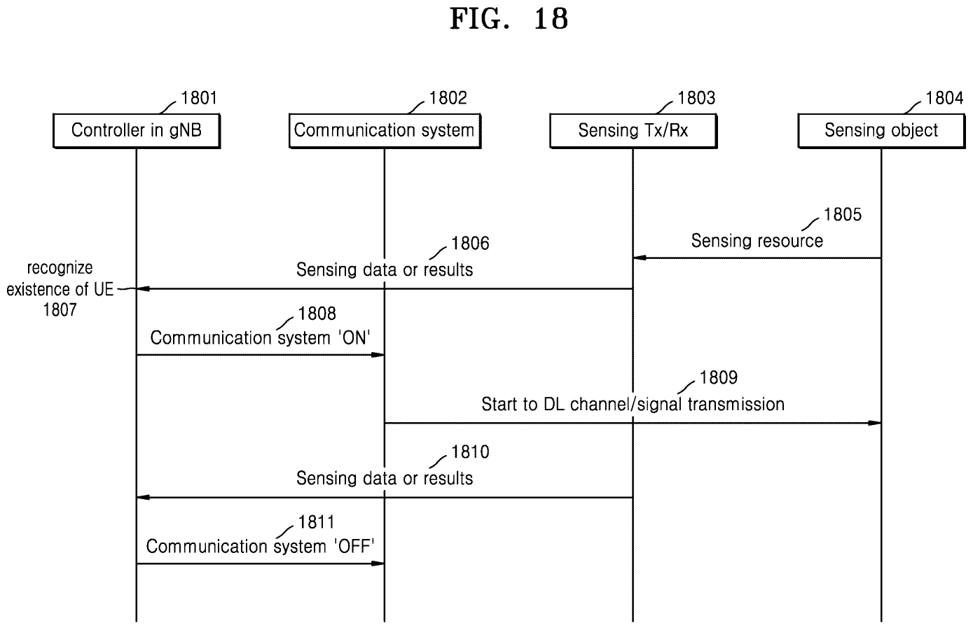

FIG. 18 is a diagram illustrating a method of determining whether a UE is present, when a BS performs sensing, according to an embodiment of the disclosure.

Referring to FIG. 18, a sensing transceiver 1803 may only perform reception of sensing signals according to sensing operation resource 1805 information configured by the BS. A UE 1804 may transmit a sensing signal based on sensing operation information preconfigured by the BS. The sensing transceiver 1803 may transmit received sensing data or result to the BS 1801, in operation 1806. The BS 1801 may determine whether a UE is present in a cell based on the transmitted sensing data or result 1806. When the BS recognizes whether a UE exists within the cell based on the transmitted sensing data or result 1806, in operation 1807, the BS may indicate activation to a communication system 1802, in operation 1808. The communication system 1802, which has received the activation indication from the BS, may resume DL data/channel transmission, in operation 1809. At the same time, the sensing transceiver 1803 may continue the sensing signal reception operation and transmit, in operation 1810, received sensing data or result to the BS 1801. Thereafter, when the BS 1801 recognizes the absence of an object within the cell based on the sensing data or result 1810 received from the sensing transceiver 1803, the BS 1801 may indicate deactivation to the communication system 1802, in operation 1811. The communication system 1802, upon receiving the deactivation indication from the BS, may stop DL data/channel transmission. Through the above method, the BS may determine whether a UE exists within a cell without a separate low-power receiver and a UE transmitting a communication signal within the communication system, and thus an energy saving effect of the communication system may be expected.

### Fifth Embodiment: Method of Identifying a Cell Status by UE when Performing Sensing

To achieve energy saving effects, a UE with sensing capabilities may perform activation/deactivation of a communication system of a sensing-based UE. When there is no separate sensing signal within the cell, the UE may determine that there is no signal transmission from the BS, stop monitoring the DL channel/signal to obtain cell information of the communication system, and switch to sleep mode. On the other hand, the UE may perform sensing to identify the cell status. When the UE receives a sensing signal from the BS through sensing, the UE may determine that the cell is active, and activate the communication system in sleep mode to resume DL channel/signal monitoring to obtain cell information. To implement the method described above, it is necessary to define a time criterion for applying activation of the communication system of the UE.

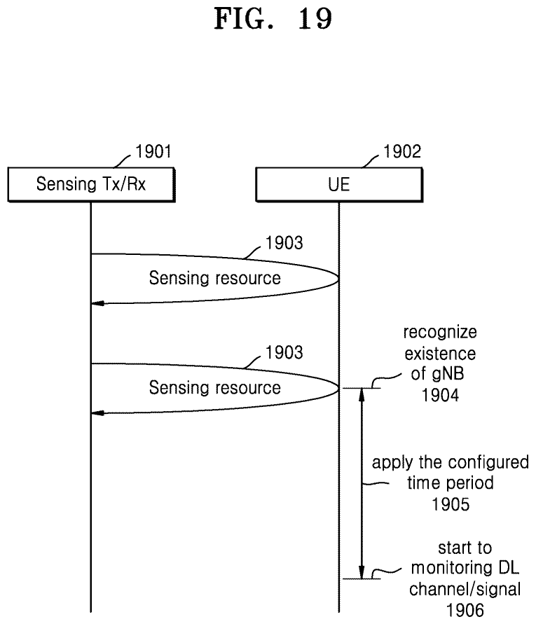

FIG. 19 is a diagram illustrating a method of activating a UE communication system according to a cell condition of a UE according to an embodiment of the disclosure.

Referring to FIG. 19, a UE 1902 may monitor a sensing signal 1903 transmitted from a sensing system 1901 of a BS. The sensing signal is a resource preconfigured by the BS, and the BS may transmit the sensing signal on the resource, and the UE may receive the sensing signal on the resource. The UE may recognize whether the cell is active, through a sensing signal resource 1903, in operation 1904. When the UE has recognized whether the cell is active, the communication system may be re-activated to perform DL channel/signal monitoring after a time resource 1905 configured from the BS, in operation 1906. When the UE does not receive a sensing signal while performing a sensing mechanism, the UE may determine that the cell has been deactivated. The UE may deactivate the communication system based on the determination.

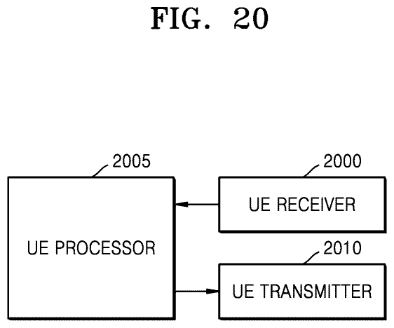

FIG. 20 is a diagram illustrating a structure of a UE in a wireless communication system according to an embodiment of the disclosure.

Referring to FIG. 20, the UE may include at least one transceiver including a UE receiver 2000 and a UE transmitter 2010, at least one memory (not shown), and at least one UE processor 2005 (or referred to as a UE controller or a processor). The UE receiver 2000 and the UE transmitter 2010, the memory, and the UE processor 2005 of the UE may operate according to the above-described communication scheme of the UE. However, elements of the UE are not limited thereto. For example, the UE may include more or fewer elements than those shown in FIG. 15. In addition, the transmitter and receiver, the memory and the UE processor may be incorporated in a single chip.

The UE receiver 2000 and the UE transmitter 2010 may transmit and receive a signal to and from a BS. The signal may include control information and data. To this end, the transceiver may include an RF transmitter for up-converting the frequency of a signal to be transmitted and amplifying the signal and an RF receiver for low-noise amplifying a received signal and down-converting the frequency of the received signal. It is, however, merely an example of the transceiver, and the elements of the transceiver are not limited to the RF transmitter and RF receiver.

In addition, the UE receiver 2000 and the UE transmitter 2010 may receive a signal on a wireless channel and output the signal to the processor, or transmit a signal output from the processor on a wireless channel.

The memory (not shown) may store programs and data required for the UE to operate. Furthermore, the memory may store control information or data included in a signal transmitted or received by the UE. The memory may include storage medium, such as read only memory (ROM), random access memory (RAM), hard disk, compact disc (CD) ROM (CD-ROM), and digital versatile disc (DVD), or a combination of storage media. Moreover, the memory may be in the plural.

The memory may be electrically, operatively, or communicatively coupled to the processor 2005 and may be accessed by the processor 2005.

The memory may store a computer program, codes, or instructions executable by the processor 2005. According to an embodiment, a computer program, codes, or instructions executable by the processor 2005 may be either stored in a single memory device or separated and distributedly stored in two or more memory devices. By executing the instructions stored in the memory, the processor 2005 may perform various functions according to an embodiment of the disclosure.

The UE processor 2005 may control a series of processes for the UE to be operated according to the embodiments of the disclosure. For example, the UE processor 2005 may control the components of the UE so that the UE receives DCI including two layers to receive a plurality of PDSCHs at the same time. There may be one or more processors including the UE processor 2005, and the UE processor 2005 may perform component control operations of the UE by executing programs stored in the memory.

The processor 2005 may control general operations of the UE according to embodiments of the disclosure. The processor 2005 may be implemented by one or more integrated circuit (or circuitry) (IC) chips and may execute various data processings. The processor 2005 may include at least one electric circuit, and may execute instructions (or a program, codes, data, etc.) stored in the memory, individually, collectively or in any combination thereof. Further, the processor 2005 may include a single-core processor or multi-core processor, and may include a processor assembly including a plurality of processing circuits (circuitry) according to a specific implementation scheme.

The processor 2005 may be electrically, operatively, or communicatively coupled to the transceiver to control the transceiver.

The processor 2005 may include at least one processor (or processing circuitry), and the at least one processor may perform the following operations individually, collectively or in any combination thereof. For example, the processor XX02 may include a communication processor (CP) configured to control communication operations and an application processor (AP) configured to control execution of an upper layer (for example, an application layer). In a specific embodiment, at least a part of the processor 2005 be included in one chip and the other part of the processor 2005 may be included in another chip. Otherwise, at least one processor may be included in another component, for example, the transceiver XX01 or the memory.

The processor 2005 may perform or control or cause an operation of the UE for executing at least one or a combination of methods according to embodiments of the disclosure. For example, the processor 2005 may control operations of the UE for processing a downlink signal received from a BS or generating and transmitting an uplink signal to a BS. To this end, the processor 2005 may execute a computer program, codes, or instructions stored in the memory, so as to control other components of the UE to enable execution of various operations.

According to an embodiment of the disclosure, operations of the UE may be caused to be performed based on execution of instructions (or a computer program or codes) stored in the memory by at least one processor (or processing circuitry) configured to execute the same individually, collectively, or in any combination thereof, based on processing circuitry that is not configured to execute instructions, and/or based on components of processing circuitry that is not configured to execute instructions.

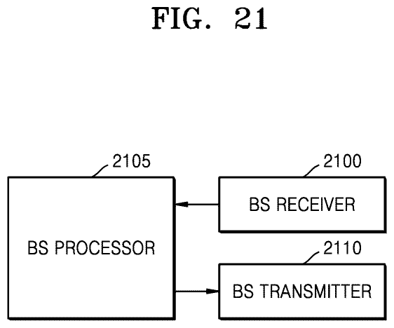

FIG. 21 is a diagram illustrating a structure of a BS in a wireless communication system according to an embodiment of the disclosure.

Referring to FIG. 21, the BS may include a transceiver including a BS receiver 2100 and a BS transmitter 2110, memory (not shown), and a BS processor 2105 (or referred to as a BS controller or a processor). The BS receiver 2100 and the BS transmitter 2110, the memory, and the BS processor 2105 of the BS may operate according to the above-described communication scheme of the BS. However, elements of the BS are not limited thereto. For example, the BS may include more or fewer elements than those shown in FIG. 14. In addition, the transceiver, the memory, and the processor may be incorporated in a single chip.

The BS receiver 2100 and the BS transmitter 2110 may transmit and receive a signal to and from a BS. The signal may include control information and data. To this end, the BS receiver 2100 and the BS transmitter 2110 may include an RF transmitter which up-converts and amplifies a frequency of a transmitted signal and an RF receiver which low nose amplifies a received signal and down-converts a frequency. It is, however, merely an example of the transceiver, and the elements of the transceiver are not limited to the RF transmitter and RF receiver.

In addition, the BS receiver 2100 and the BS transmitter 2110 may receive a signal on a wireless channel and output the signal to the processor, or transmit a signal output from the processor on a wireless channel.

The memory (not shown) may store programs and data required for the BS to operate. Furthermore, the memory may store control information or data included in a signal transmitted or received by the BS. The memory may include storage medium, such as ROM, random access memory RAM, hard disk, CD-ROM, and digital versatile disc (DVD), or a combination of storage media. Moreover, the memory may be in the plural.

The memory may be electrically, operatively, or communicatively coupled to the processor 2105 and may be accessed by the processor 2105.

The memory may store a computer program, codes, or instructions executable by the processor 2105. According to an embodiment, a computer program, codes, or instructions executable by the processor 2105 may be either stored in a single memory device or separated and distributedly stored in two or more memory devices. By executing the instructions stored in the memory, the processor 2105 may perform various functions according to an embodiment of the disclosure.

The BS processor 2105 may control a series of processes to allow the BS to operate according to the above-described embodiments of the disclosure. For example, the BS processor 2105 may control the components of the BS to configure and transmit pieces of DCI of two layers, which include assignment information for a plurality of PDSCHs. There may be one or more processors including the BS processor 2105, and the BS processor 2105 may perform component control operations of the BS by executing programs stored in the memory.

The processor 2105 may control general operations of the BS according to embodiments of the disclosure. The processor 2105 may be implemented by one or more integrated circuit (or circuitry) (IC) chips and may execute various data processings. The processor 2105 may include at least one electric circuit, and may execute instructions (or a program, codes, data, etc.) stored in the memory, individually, collectively or in any combination thereof. Further, the processor 2105 may include a single-core processor or multi-core processor, and may include a processor assembly including a plurality of processing circuits (circuitry) according to a specific implementation scheme.

The processor 2105 may be electrically, operatively, or communicatively coupled to the transceiver to control the transceiver.

The processor 2105 may include at least one processor (or processing circuitry), and the at least one processor may perform the following operations individually, collectively or in any combination thereof. In a specific embodiment, at least a part of the processor 2105 may be included in one chip and the other part of the processor 2105 may be included in another chip. Otherwise, at least one processor may be included in another component, for example, the transceiver or the memory.

The processor 2105 may perform or control or cause an operation of the BS for executing at least one or a combination of methods according to embodiments of the disclosure. For example, the processor 2105 may control operations of the BS for generating and transmitting a downlink signal to a UE or processing an uplink signal received from a UE. Otherwise, the BS may transmit or receive a signal to or from a neighboring BS, transfer a signal received from a UE to an upper node of the network, or transmit a signal transferred from an upper node of the network to a UE. To this end, the processor 2105 may execute a computer program, codes, or instructions stored in the memory, so as to control other components of the BS to enable execution of various operations.

According to an embodiment of the disclosure, operations of the BS may be caused to be performed based on execution of instructions (or a computer program or codes) stored in the memory by at least one processor (or processing circuitry) configured to execute the same individually, collectively, or in any combination thereof, based on processing circuitry that is not configured to execute instructions, and/or based on components of processing circuitry that is not configured to execute instructions.

The methods, according to the embodiments of the disclosure as described herein or in the following claims, may be implemented as hardware, software, or a combination of hardware and software.

When implemented in software, a computer-readable storage medium storing one or more programs (e.g., software modules) may be provided. The one or more programs stored in the computer-readable storage medium are configured for execution by one or more processors in an electronic device. The one or more programs include instructions causing the electronic device to execute the methods according to the embodiments of the disclosure as described in the claims and the specification.

The programs (e.g., software modules or software) may be stored in RAM, non-volatile memory including flash memory, ROM, electrically erasable programmable read-only memory (EEPROM), magnetic disc storage device, CD-ROM, DVD, another optical storage device, or magnetic cassette. Alternatively, the programs may be stored in memory including a combination of some or all of the above-mentioned storage media. A plurality of such memories may be included.

In addition, the programs may be stored in an attachable storage device accessible through any or a combination of communication networks, such as the Internet, an intranet, a local area network (LAN), a wide LAN (WLAN), and a storage area network (SAN). Such a storage device may access the electronic device via an external port. Furthermore, an additional storage device on the communication network may access a device which performs embodiments of the disclosure.

In specific embodiments of the disclosure described above, components included in the disclosure were expressed as singular or plural in accordance with the specific embodiments of the disclosure set forth. However, the singular or plural form is selected properly for a situation assumed for convenience of description and does not limit the disclosure, and elements expressed in a plural form may include a single element and an element expressed in a singular form may include a plurality of elements.

Meanwhile, the embodiments disclosed in the specification and drawings are merely presented to easily describe the technical content of the disclosure and help understanding of the disclosure, and are not intended to limit the scope of the disclosure. For example, it will be obvious to one of ordinary skill in the art to which the disclosure belongs that different modifications may be achieved based on the technical spirit of the disclosure. In addition, when necessary, the above respective embodiments may be employed in combination. For example, an embodiment of the disclosure and some of another embodiment of the disclosure may be combined to operate the BS and the UE. For example, portions of the first embodiment to the fifth embodiment may be combined to operate the BS and the UE. Although the embodiments of the disclosure are provided with respect to an FDD LTE system, modifications of the embodiments of the disclosure based on the technical idea of the above embodiments of the disclosure may also be employed by other systems, such as a TDD LTE system, a 5G or NR system, or the like.

The description order of the method of the disclosure as in the drawings may not exactly correspond to actual execution order, but may be performed reversely or in parallel.

Some of the components shown in the drawings may be omitted within a range that does not deviate the scope of the disclosure.

In the disclosure, a method may be performed by combining some or all of what are described in the respective embodiments of the disclosure within the scope of the disclosure.

Various embodiments of the disclosure have been described. The embodiments of the disclosure described above are merely examples, and the disclosure is not limited thereto. It will be understood by one of ordinary skill in the art that the embodiments of the disclosure may be easily modified in other specific forms all without changing the technical idea or the essential features of the disclosure. The scope of the disclosure is defined by the appended claims rather than the detailed description, and all changes or modifications within the scope of the appended claims and their equivalents will be construed as being included in the scope of the disclosure.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Provided are a device and a method capable of effectively providing services in a mobile communication system.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

Meanwhile, although specific embodiments of the present disclosure have been described in detail, various modifications may be made without departing from the scope of the present disclosure. Therefore, the scope of the present disclosure should not be limited to the described embodiments, but should be defined by the claims and equivalents thereof.

What is claimed is:

1. A method performed by a base station (BS) in a wireless communication system, the method comprising:
obtaining sensing information corresponding to a signal reflected from a sensing object;
based on the sensing information, determining whether the sensing object is present in at least one cell;
based on determining that the sensing object is present in the at least one cell, activating a main radio (MR) for the at least one cell; and
based on determining that the sensing object is not present in the at least one cell, deactivating the MR for the at least one cell of the BS.

2. The method of claim 1, further comprising:
operating in a sensing receive-only mode;
receiving, an uplink (UL) signal transmitted by at least one user equipment (UE) on a pre-configured sensing resource;
based on the received UL signal, identifying the sensing object as the at least one UE; and
based on the identifying the sensing object as the at least one UE, activating the MR for the at least one cell.

3. The method of claim 1, when activating the MR for the at least one cell, further comprising:
indicating, to the MR for the at least one cell, to start monitoring a UL signal transmitted by at least one user equipment (UE) on a pre-configured sensing resource;
receiving, an uplink (UL) signal transmitted by the at least one UE on the pre-configured sensing resource;
based on the received UL signal, identifying the sensing object as the at least one UE; and
based on the identifying the sensing object as the at least one UE, transmitting, via the MR for the at least one cell of the BS, downlink (DL) data channel to the at least one UE.

4. The method of claim 1, further comprising:
transmitting, to a user equipment (UE), sensing related configuration information;
receiving, a sensing signal transmitted by at least one UE based on the sensing related configuration information;
based on the sensing signal, identifying the sensing object as the at least one UE; and
based on the identifying the sensing object as the at least one UE, activating the MR for the at least one cell of the BS.

5. The method of claim 1, further comprising:
configuring, a cell-specific sensing resource for the at least one cell, as at least a portion of a downlink (DL) resource, uplink (UL) resource, or flexible resource based on time division duplex (TDD) UL-DL configuration information; and
performing sensing on the at least one cell based on the cell-specific sensing resource for the at least one cell.

6. The method of claim 5, further comprising:
configuring, for the at least one cell, a periodicity of the cell-specific sensing resource.

7. The method of claim 1, further comprising:
configuring, for the at least one cell, a monitoring periodicity of the signal reflected from the sensing object.

8. The method of claim 1, further comprising:
transmitting, to a user equipment (UE), sensing related configuration information; and
transmitting, on the at least one cell of the BS, to the UE, a sensing signal on a pre-configured sensing resource, based on the sensing related configuration information,
wherein, based on the sensing signal, the MR of the UE is activated to perform downlink (DL) channel monitoring.

9. A method performed by a user equipment (UE) in a wireless communication system, the method comprising:
receiving, from a base station (BS), sensing related configuration information; and
transmitting, to at least one cell of the BS, an uplink (UL) signal on a pre-configuration sensing resource, based on the sensing related configuration information,
wherein, when the UL signal is received by the at least one cell of the BS, a main radio (MR) for the at least one cell of the BS is activated, and
wherein, when the UL signal is note received by the at least one cell of the BS, the MR for the at least one cell of the BS is deactivated.

10. The method of claim 9, further comprising:
monitoring a sensing signal on the pre-configured sensing resource, based on the sensing related configuration information;
based on whether the sensing signal is received on the pre-configured sensing resource from the at least one cell of the BS, identifying whether the MR for the at least one cell of the BS is activated or is deactivated;
based on identifying that the MR for the at least one cell of the BS is activated, activating a MR of the UE to perform downlink (DL) channel monitoring; and
based on identifying that the MR for the at least one cell of the BS is deactivated, deactivating the MR of the UE.

11. The method of claim 10, further comprising:
receiving, from the BS, information on a time period for activating the MR of the UE;
when determining that the MR for the at least one cell of the BS is activated, waiting for the time period; and
after the time period, activating the MR of the UE to perform DL channel monitoring.

12. A base station (BS) in a wireless communication system, the BS comprising:
at least one transceiver;
at least one processor communicatively coupled to the at least one transceiver; and
at least one memory, communicatively coupled to the at least one processor, storing instructions executable by the at least one processor individually or in any combination to cause the BS to:
obtain sensing information corresponding to a signal reflected from a sensing object,
based on the sensing information, determine whether the sensing object is present in at least one cell,
based on determining that the sensing object is present in the at least one cell, activate a main radio (MR) for the at least one cell, and
based on determining that the sensing object is not present in the at least one cell, deactivate the MR for the at least one cell of the BS.

13. The BS of claim 12, wherein the instructions are further executable by the at least one processor individually or in any combination to cause the BS to:
operate in a sensing receive-only mode,
receive, an uplink (UL) signal transmitted by at least one user equipment (UE) on a pre-configured sensing resource,
based on the received UL signal, identify the sensing object as the at least one UE, and
based on the identifying the sensing object as the at least one UE, activate the MR for the at least one cell.

14. The BS of claim 12, when activating the MR for the at least one cell, wherein the instructions are further executable by the at least one processor individually or in any combination to cause the BS to:
indicate, to the MR for the at least one cell, to start monitoring a UL signal transmitted by at least one user equipment (UE) on a pre-configured sensing resource,
receive, an uplink (UL) signal transmitted by the at least one UE on the pre-configured sensing resource,
based on the received UL signal, identify the sensing object as the at least one UE, and
based on the identifying the sensing object as the at least one UE, transmit, via the MR for the at least one cell of the BS, downlink (DL) data channel to the at least one UE.

15. The BS of claim 12, wherein the instructions are further executable by the at least one processor individually or in any combination to cause the BS to:
transmit, to a user equipment (UE), sensing related configuration information,
receive, a sensing signal transmitted by at least one UE based on the sensing related configuration information,
based on the sensing signal, identify the sensing object as the at least one UE, and
based on the identifying the sensing object as the at least one UE, activate the MR for the at least one cell of the BS.

16. The BS of claim 12, wherein the instructions are further executable by the at least one processor individually or in any combination to cause the BS to:
configure, a cell-specific sensing resource for the at least one cell, as at least a portion of a downlink (DL) resource, uplink (UL) resource, or flexible resource based on time division duplex (TDD) UL-DL configuration information, and
perform sensing on the at least one cell based on the cell-specific sensing resource for the at least one cell.

17. The BS of claim 12, wherein the instructions are further executable by the at least one processor individually or in any combination to cause the BS to:
transmit, to a user equipment (UE), sensing related configuration information, and
transmit, on the at least one cell of the BS, to the UE, a sensing signal on a pre-configured sensing resource, based on the sensing related configuration information,
wherein, based on the sensing signal, the MR of the UE is activated to perform downlink (DL) channel monitoring.

18. A user equipment (UE) in a wireless communication system, the UE comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station (BS), sensing related configuration information, and
transmit, to at least one cell of the BS, an uplink (UL) signal on a pre-configuration sensing resource, based on the sensing related configuration information,
wherein, when the UL signal is received by the at least one cell of the BS, a main radio (MR) for the at least one cell of the BS is activated, and
wherein, when the UL signal is note received by the at least one cell of the BS, the MR for the at least one cell of the BS is deactivated.

19. The UE of claim 18, wherein the instructions are further executable by the at least one processor individually or in any combination to cause the UE to:
monitor a sensing signal on the pre-configured sensing resource, based on the sensing related configuration information,
based on whether the sensing signal is received on the pre-configured sensing resource from the at least one cell of the BS, identify whether the MR for the at least one cell of the BS is activated or is deactivated,
based on identify that the MR for the at least one cell of the BS is activated, activate a MR of the UE to perform downlink (DL) channel monitoring, and
based on identify that the MR for the at least one cell of the BS is deactivated, deactivate the MR of the UE.

20. The UE of claim 18, wherein the instructions are further executable by the at least one processor individually or in any combination to cause the UE to:
receive, from the BS, information on a time period for activating the MR of the UE,
when determining that the MR for the at least one cell of the BS is activated, wait for the time period, and
after the time period, activate the MR of the UE to perform DL channel monitoring.
